(19) United States
(12) Patent Application Publication
(10) Pub. No.: US 2026/0260494 A1
(43) Pub. Date: Sep. 3, 2026

(54) DETECTING SUBOPTIMAL PERFORMANCE OF SECURITY CHECK OPERATIONS

(71) Applicant: Athena Security, Inc., Austin, TX (US)

(72) Inventor: Christopher Carlo Ciabarra, Ciabarra, FL (US)

(21) Appl. No.: 19/656,192

(22) Filed: Apr. 23, 2026

Related U.S. Application Data
(63) Continuation-in-part of application No. 18/357,905, filed on Jul. 24, 2023.
(60) Provisional application No. 63/369,375, filed on Jul. 26, 2022.

(51) Int. Cl. G06V 20/52; G06T 7/20

(52) U.S. Cl. CPC G06V 20/52; G06T 7/20

(57) ABSTRACT

A security checkpoint system comprises sensors collecting data points on movements within a checkpoint area. A processing unit generates wireframe models of persons based on the data points, analyzes movements to detect potential evasion attempts of screening procedures, and generates alerts. The system monitors officer movements for protocol adherence. Multiple persons are tracked simultaneously. Artificial intelligence analyzes wireframe models and/or audio data to identify suspicious and/or dangerous patterns. The system detects evasion attempts like moving around detectors, concealing objects, or passing quickly through screening. Alerts are sent to a security operations center. The system provides enhanced threat detection through multi-sensor data fusion and AI-powered analysis. Cost-effective and efficient security screening is achieved.

### CROSS-REFERENCE TO RELATED APPLICATIONS

This application is a continuation-in-part of, and claims priority to and the benefit of U.S. Patent Application Serial No. 18/357,905, titled “Detecting Suboptimal Performance of Security Check Operations,” filed July 24, 2023, which claims priority to and the benefit of U.S. Provisional Application No. 63/369,375, titled “ALERT ON HUMAN ERRORS WHILE USING OR OPERATING A METAL DETECTOR,” filed July 26, 2022, and, the entire disclosures of which are hereby incorporated herein by reference.

### FIELD OF INVENTION

The present disclosure relates generally to security systems and more particularly to automated monitoring and analysis of security checkpoint operations using environmental data and artificial intelligence.

### BACKGROUND OF THE DISCLOSURE

A security check environment can be implemented at entrance points of office buildings, government buildings, courthouses, mass transportation terminals (e.g., airports, train stations, bus stations, etc.), convention centers, stadiums, casinos, stores, schools, hospitals, and other buildings or spaces where security checks of human patrons are performed by prohibited object detectors and/or human security officers. A security check environment may comprise a prohibited object detector operable to detect a potentially prohibited object (e.g., a metal object, a sharp object, a dense object, a large object, etc.), one or more human security officers stationed near the prohibited object detector, one or more human patrons (e.g., employees, visitors, travelers, spectators, vacationers, shoppers, students, etc.) who intend to walk through the prohibited object detector to gain access to their intended destination, one or more barriers (e.g., fencing, railing, walls, etc.) for limiting movement of the human patrons and directing the human patrons toward and through the prohibited object detector, one or more objects (e.g., handbags, backpack, wallets, box containers, etc.) carried by the human patrons, and/or one or more security tables for supporting the carried objects such that they can be examined by the human security officers.

During security check operations, a prohibited object detector may be used to check (or scan) human patrons for prohibited objects (e.g., firearms, knives, explosives, etc.) by detecting potentially prohibited objects carried by the human patrons. The potentially prohibited objects may be carried openly or in a concealed manner within a carried object by a human patron as the human patron walks through the prohibited object detector to his or her intended destination. When the prohibited object detector detects a potentially prohibited object, the prohibited object detector may output an audio and/or visual alarm. In response to the alarm, a human security officer may instruct the human patron to walk back through the prohibited object detector, and then perform an additional security check of the human patron and/or the object carried by the human patron. For example, a human security officer may physically check (e.g., open) the carried object or physically check the human patron (e.g., execute a pat down, scan with a handheld metal detector, request to empty pockets, etc.) in an attempt to find or otherwise identify the potentially prohibited object. When the human security officer finds or identifies the potentially prohibited object, the human security officer may request the human patron to walk again through the prohibited object detector, but without the potentially prohibited object, to check the human patron for additional potentially prohibited objects. When the human patron again passes through the prohibited object detector and the prohibited object detector does not output an audio and/or visual alarm, the human security officer may then permit the human patron to leave the security check environment toward their intended destination.

During security check operations, human security officers may manage the security check operations, such as by operating a prohibited object detector, directing movement of human patrons through a prohibited object detector, and checking human patrons for prohibited objects. However, security check operations may be performed in a suboptimal manner because of erroneous, unintended, improper, deceitful, or otherwise suboptimal actions performed by human patrons and/or human security officers during and/or in preparation for security check operations. Suboptimal performance of security check operations may include a human patron using a prohibited object detector in a suboptimal (e.g., erroneous, deceitful) manner, a human security officer operating or using a prohibited object detector or other security equipment in a suboptimal (e.g., erroneous, unintended, etc.) manner, a human security officer manually performing security check operations on a human patron in a suboptimal (e.g., erroneous, unintended, etc.) manner, and/or a human security officer configuring a prohibited object detector in a suboptimal manner for use during security check operations.

One major issue is the potential for suboptimal performance of security checks due to human error or deception. Patrons may attempt to evade screening through erroneous or deceitful actions. Similarly, security officers may unintentionally operate equipment improperly or conduct manual checks ineffectively. These human factors introduce vulnerabilities that could allow prohibited items to bypass detection.

For example, when a prohibited object detector is moved linearly and/or rotated, without a human security officer noticing, a space (or gap) can be formed or become larger with respect to a barrier, permitting a human patron to fit through the space between the prohibited object detector and the barrier, and walk around or otherwise bypass the prohibited object detector, also without a human security officer noticing. Furthermore, when portions of a prohibited object detector are moved linearly (i.e., closer together or further apart) and/or rotated with respect to the other, without a human security officer noticing, a detection area (or space) of the prohibited object detector may contract (i.e., shrink) or otherwise lose its detection effectiveness, thereby permitting a human patron to carry a potentially prohibited object through the prohibited object detector without detection.

Limitations in the prohibited object detectors themselves pose further challenges. Most detectors can only identify the presence of suspicious materials or objects, not their exact nature. This often necessitates time-consuming secondary screening to determine if detected items are truly prohibited. The detectors may also struggle with certain concealment methods or have blind spots that skilled individuals could exploit.

Human factors on the security officer side introduce additional vulnerabilities. Officers may become fatigued or distracted during long shifts, reducing their vigilance. Inconsistent application of protocols between different officers can create gaps in security. There is also the potential for insider threats if officers are compromised or act maliciously.

The high-volume, fast-paced nature of many security checkpoints compounds these issues. Officers face pressure to process large numbers of patrons quickly, which can lead to rushed or incomplete screening. This environment makes it challenging to give each patron thorough, individualized attention.

Therefore, there is a need to overcome the problems discussed above. An improved system is required that can enhance the effectiveness of security screening while accounting for human limitations and potential evasion attempts. Such a system should be able to comprehensively monitor the checkpoint environment, detect suspicious behaviors and movements, and alert security personnel to potential threats in real-time. Additionally, it should be capable of analyzing officer performance to ensure adherence to protocols and identifying areas for improvement in security operations.

### SUMMARY

One objective of the present disclosure is to provide an enhanced security checkpoint system that utilizes artificial intelligence to analyze movements and detect potential evasion attempts.

Another objective of the present disclosure is to create a system that can collect and process data points from multiple sensors to generate wireframe models of persons in a security checkpoint area.

Yet another objective of the present disclosure is to offer a method for monitoring both visitors and security officers to ensure adherence to proper security screening protocols.

Still another objective of the present disclosure is to provide a security system capable of detecting various evasion techniques, including attempts to conceal objects or bypass screening equipment.

According to one objective of the present disclosure, a security checkpoint system is provided comprising a plurality of sensors configured to collect data points related to movements of persons within a security checkpoint area. The system includes a processing unit configured to receive the collected data points from the plurality of sensors, generate a wireframe model of at least one person based on the collected data points, and analyze movements of the wireframe model to detect potential evasion attempts of security screening procedures and/or the use of improper screening protocols. An alert mechanism is configured to generate an alert when a potential evasion attempt is detected.

The security checkpoint system may comprise various types of sensors, including video cameras, LIDAR sensors, millimeter wave sensors, ultrasound sensors, and radio frequency sensors. This diverse array of sensors allows for comprehensive data collection and analysis.

The processing unit of the security checkpoint system is capable of tracking multiple persons simultaneously within the security checkpoint area, enhancing the system's ability to monitor complex environments such as busy airport terminals or concert venues.

In addition to monitoring visitors, the processing unit is configured to analyze movements and/or speech of security officers within the security checkpoint area to determine adherence to security screening protocols. This feature helps ensure that proper procedures are followed consistently.

The system is designed to detect various potential evasion attempts, including moving around a metal detector, placing an object over a detection area, moving an object quickly through a detection area, and concealing an object in a body area that may interfere with detection.

To facilitate prompt response to security issues, the security checkpoint system may include a security operations center configured to receive alerts generated by the alert mechanism.

The processing unit may also be capable of analyzing audio data collected within the security checkpoint area to detect potential security issues, providing an additional layer of threat detection.

For improved accuracy in spatial analysis, the system may include a plurality of sensors that includes at least two sensors configured to provide depth perception data, such as LIDAR or stereoscopic cameras.

The processing unit may be programmed to compare detected movements to predefined security screening procedures to identify deviations, ensuring that both visitors and security personnel adhere to established protocols.

The wireframe model generated by the system preferably includes data points representing joints and body parts of the person being monitored, allowing for detailed analysis of movement patterns.

According to another objective of the present disclosure, a method for enhancing security screening is provided. The method preferably comprises collecting, by a plurality of sensors, data points related to movements of persons within a security checkpoint area; generating, by a processing unit, a wireframe model of at least one person based on the collected data points; analyzing, by the processing unit, movements of the wireframe model to detect potential evasion attempts of security screening procedures; and generating an alert when a potential evasion attempt is detected.

The method preferably includes the capability of tracking multiple persons simultaneously within the security checkpoint area, allowing for comprehensive monitoring of complex environments.

As part of the method, movements of security officers within the security checkpoint area are preferably analyzed to determine adherence to security screening protocols, ensuring that proper procedures are consistently followed.

The method preferably encompasses detecting various potential evasion attempts, including identifying movements such as going around a metal detector, placing an object over a detection area, moving an object quickly through a detection area, and concealing an object in a body area that may interfere with detection.

Audio data collected within the security checkpoint area is preferably analyzed as part of the method to detect potential security issues, providing an additional layer of threat detection beyond visual and spatial analysis.

The method preferably involves comparing detected movements to predefined security screening procedures to identify deviations, ensuring that both visitors and security personnel adhere to established protocols.

According to yet another objective of the present disclosure, a non-transitory computer-readable storage medium is provided, preferably storing instructions that, when executed by a processor, cause the processor to perform a method for enhancing security screening. The method preferably comprises receiving data points collected by a plurality of sensors related to movements of persons within a security checkpoint area; generating a wireframe model of at least one person based on the received data points; analyzing movements of the wireframe model to detect potential evasion attempts of security screening procedures; and initiating generation of an alert when a potential evasion attempt is detected.

The method performed by the processor preferably includes tracking multiple persons simultaneously within the security checkpoint area, allowing for comprehensive monitoring of complex environments.

As part of the method, the processor preferably analyzes movements of security officers within the security checkpoint area to determine adherence to security screening protocols, ensuring that proper procedures are consistently followed.

The method preferably encompasses detecting various potential evasion attempts, including identifying movements such as going around a metal detector, placing an object over a detection area, moving an object quickly through a detection area, and concealing an object in a body area that may interfere with detection.

The security checkpoint system preferably utilizes artificial intelligence to analyze the wireframe model for potential evasive actions, enhancing the system's ability to detect subtle or complex evasion attempts.

The artificial intelligence component preferably comprises a machine learning model trained on data points collected from previously deployed security checkpoint systems or from staged or simulated interactions displaying good and/or bad results, allowing the system to continuously improve its detection capabilities.

The artificial intelligence is preferably configured to identify patterns of movement associated with known evasion techniques, enabling proactive threat detection.

The method for enhancing security screening preferably incorporates artificial intelligence to analyze the wireframe model for potential evasive actions, providing advanced threat detection capabilities.

The artificial intelligence used in the method preferably comprises a machine learning model that is continuously updated with data points collected from the security checkpoint area, allowing for real-time adaptation to new threats or evasion techniques.

The artificial intelligence is preferably designed to adapt its analysis based on the specific security screening equipment deployed in the security checkpoint area, ensuring optimal performance across different security environments.

The non-transitory computer-readable storage medium preferably stores instructions for employing artificial intelligence to analyze the wireframe model for potential evasive actions, enhancing the system's threat detection capabilities.

The artificial intelligence used in the computer-implemented method is preferably configured to distinguish between normal movements and suspicious movements based on historical data from multiple security checkpoint environments, reducing false positives and improving detection accuracy.

The artificial intelligence preferably analyzes the speed and trajectory of movements within the wireframe model to identify potential evasion attempts, allowing for detection of subtle or quick evasive actions.

The security checkpoint system's artificial intelligence is preferably configured to correlate movements detected in the wireframe model with audio data collected from the security checkpoint area to enhance evasion detection accuracy.

The system preferably includes at least one microphone among its plurality of sensors, and the processing unit is configured to use artificial intelligence to analyze captured sound data to detect potential security threats.

The artificial intelligence is preferably programmed to identify specific sound patterns associated with security threats, including elevated voices, aggressive tones, impact noises, and calls for help, providing an additional layer of threat detection.

The processing unit of the security checkpoint system is preferably configured to correlate the analyzed sound data with the wireframe model movements to enhance detection of potential security threats, allowing for a more comprehensive threat assessment.

The method for enhancing security screening preferably includes capturing sound data within the security checkpoint area and using artificial intelligence to analyze the captured sound data to detect potential security threats.

The method preferably involves correlating the analyzed sound data with the analyzed movements of the wireframe model to enhance detection accuracy of potential security threats, providing a multi-modal approach to threat detection.

The artificial intelligence used in the method is preferably configured to adapt its sound analysis based on ambient noise profiles specific to different security checkpoint environments, ensuring accurate threat detection across various settings.

The non-transitory computer-readable storage medium preferably stores instructions for receiving captured sound data from the security checkpoint area and employing artificial intelligence to analyze the captured sound data in conjunction with the wireframe model movements to detect potential security threats.

The artificial intelligence used in the computer-implemented method is preferably trained to recognize audio cues indicating discomfort or agitation of persons within the security checkpoint area, allowing for early detection of potential security issues.

The security checkpoint system's artificial intelligence is preferably configured to analyze the captured sound data for keywords or phrases indicating potential security threats, providing text-based threat detection capabilities.

The method preferably includes generating an alert based on a combination of detected suspicious movements in the wireframe model and analyzed sound data indicating a potential security threat, allowing for more accurate and comprehensive threat assessment.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a schematic view of at least a portion of an example implementation of apparatus according to one or more aspects of the present disclosure.

FIG. 3 is a schematic view of at least a portion of an example implementation of apparatus according to one or more aspects of the present disclosure.

FIG. 4 is a schematic view of at least a portion of an example implementation of apparatus according to one or more aspects of the present disclosure.

FIG. 5 is a schematic view of at least a portion of an example implementation of apparatus according to one or more aspects of the present disclosure.

FIG. 6 is a schematic view of at least a portion of an example implementation of apparatus according to one or more aspects of the present disclosure.

FIG. 7 is a schematic view of at least a portion of an example implementation of apparatus according to one or more aspects of the present disclosure.

FIG. 8 is a schematic view of at least a portion of an example implementation of apparatus according to one or more aspects of the present disclosure.

FIG. 9 is a schematic view of at least a portion of an example implementation of apparatus according to one or more aspects of the present disclosure.

FIG. 10 is a schematic view of at least a portion of an example implementation of apparatus according to one or more aspects of the present disclosure.

FIG. 11 is a view of a possible evasion attempt according to one or more aspects of the present disclosure.

FIG. 12 is a view of a scanning procedure overlaid with an inference of two wireframe skeletons according to one or more aspects of the present disclosure.

FIG. 13 is a view of an evasion attempt according to one or more aspects of the present disclosure.

FIG. 14 is a view of an evasion attempt according to one or more aspects of the present disclosure.

FIG. 15 is a view of a flow chart regarding processing of auditory inputs according to one or more aspects of the present disclosure.

FIG. 16 is a view of a block diagram of multiple security check environments according to one or more aspects of the present disclosure.

FIG. 17 is a view of a block diagram of various screening positions within a checkpoint according to one or more aspects of the present disclosure.

FIG. 18 is a view of an embodiment of an automated scanning robot according to one or more aspects of the present disclosure.

FIG. 19 is a view of an embodiment of an automated scanning robot according to one or more aspects of the present disclosure.

### DETAILED DESCRIPTION OF PREFERRED EMBODIMENTS

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Various non-limiting embodiments of the inventive systems and methods are set forth below.

The security checkpoint system may comprise a plurality of sensors configured to collect data points related to movements of persons within a security checkpoint area. The sensors may include video cameras, LIDAR sensors, millimeter wave sensors, ultrasound sensors, and radio frequency sensors to provide comprehensive coverage. A processing unit receives the collected data points from the sensors and generates a wireframe model of at least one person based on the data points. The processing unit analyzes movements of the wireframe model to detect potential evasion attempts of security screening procedures. An alert mechanism generates an alert when a potential evasion attempt is detected.

The processing unit can track multiple persons simultaneously within the checkpoint area to monitor crowd behavior and flow. This allows detection of coordinated evasion attempts involving multiple actors. The system analyzes movements of security officers to determine adherence to screening protocols, helping ensure proper procedures are followed consistently. Potential evasion attempts that can be detected include moving around a metal detector, placing an object over a detection area, moving an object quickly through a detection area, and concealing an object in a body area that may interfere with detection.

A security operations center receives alerts generated by the alert mechanism to enable rapid response to potential threats. The processing unit can analyze audio data collected within the checkpoint area, such as from microphones, to detect verbal cues indicating potential security issues. At least two sensors are configured to provide depth perception data, enabling 3D modeling and analysis of movements. The processing unit compares detected movements to predefined security screening procedures to identify deviations that may indicate evasive behavior.

The wireframe model includes data points representing joints and body parts of persons being monitored. This allows detailed analysis of body positioning and movements. The model can be analyzed to detect unnatural movements or postures that may indicate concealment of objects. Machine learning algorithms can be trained on historical data to improve detection accuracy over time. The system provides continuous automated monitoring to enhance security screening effectiveness.

An alternative embodiment utilizes thermal imaging cameras in addition to visible light cameras. The thermal imaging can detect concealed objects based on temperature differences. Another embodiment incorporates millimeter wave scanners to provide imaging through clothing. This allows detection of objects hidden under garments without requiring physical pat-downs. A further embodiment uses chemical trace detectors at checkpoint entry points to identify potential explosive residues.

An additional embodiment employs distributed edge computing to enable real-time processing of high-bandwidth sensor data. This allows more sophisticated analysis algorithms to be run locally at each checkpoint. Another variation uses secure communication protocols to protect data transmission between system components. The protocols use end-to-end encryption to prevent interception of sensitive information.

The security checkpoint system can adapt to different threat levels and screening protocols. Configuration options allow adjustment of detection thresholds and alert criteria based on current security needs. For example, during periods of elevated threat, the system may lower thresholds for generating alerts. The system may employ different analysis models for various traveler types like adults, children, or those with medical devices. Seasonal models can be used to account for changes in clothing or luggage patterns.

The system can be quickly updated to detect new threat types or evasion techniques as they emerge. For instance, if a novel concealment method is discovered, the machine learning models can be retrained to recognize the new pattern. This allows the system to stay ahead of evolving security threats. The processing unit may use transfer learning techniques to adapt pre-trained models to specific checkpoint environments with minimal additional training data.

Human-in-the-loop processes allow security personnel to provide feedback on system alerts, improving model accuracy over time. For example, false positive alerts can be flagged to tune detection algorithms. The system may include a simulation mode for training security staff on new threats or procedures. This allows personnel to practice responding to various security scenarios in a safe environment. Comprehensive logging and auditing features enable detailed review of checkpoint operations.

The system can generate automated reports on checkpoint performance metrics, evasion attempts detected, and recommended process improvements. For instance, it may identify bottlenecks in passenger flow or areas where screening procedures are inconsistently applied. Regular penetration testing can be conducted to verify system security and identify potential vulnerabilities. This helps ensure the integrity of the checkpoint system itself.

The security checkpoint system can be integrated with biometric identification systems to associate detected behaviors with specific individuals. This enables tracking of persons of interest across multiple checkpoints or visits. For example, if suspicious behavior is observed, the system could flag that individual for enhanced screening on future visits. The system may interface with watch lists and threat databases to flag known or suspected persons of concern in real-time as they enter the checkpoint area.

Behavioral baselines can be established for frequent travelers to detect deviations from their normal patterns. For instance, the system may learn a regular business traveler's typical luggage contents and flag unusual items. The system can analyze group dynamics to identify potential coordinated threats involving multiple actors. This could detect suspicious synchronized movements or communication patterns between individuals in the checkpoint area.

Advanced sensor types that may be incorporated include hyperspectral imaging cameras for detecting specific chemical signatures and terahertz scanners for high-resolution imaging of concealed objects. Sensor fusion algorithms combine data from multiple sources to improve detection accuracy and reduce false positives and false negatives. For example, the system may correlate unusual movements detected in video with anomalous readings from a chemical sensor to increase confidence in a potential threat.

The system may employ different analysis models for various checkpoint configurations. For example, a multi-lane vehicle checkpoint may use different algorithms than a pedestrian entry point. The models can be optimized for the specific sensor layouts and screening procedures used in each environment. The system can generate real-time heatmaps of checkpoint activity to identify congestion points and optimize passenger flow. This allows dynamic adjustment of staffing levels and lane configurations.

The system may interface with passenger information systems to correlate identity data with detected behaviors. For instance, it could flag discrepancies between a traveler's stated purpose of visit and observed behaviors. Privacy-preserving techniques like data anonymization can be employed to protect individual rights while maintaining security capabilities.

Machine learning models used may include convolutional neural networks for image/video analysis, recurrent neural networks for temporal pattern detection, and ensemble methods combining multiple model types. Transfer learning techniques allow adaptation of pre-trained models to specific checkpoint environments with minimal additional training data. Online learning enables continuous improvement of models based on new data collected during operation.

Explainable AI methods can be employed to provide human-interpretable justifications for system alerts. This allows security personnel to understand the reasoning behind automated threat detections. For example, the system may highlight specific movements or object detections that contributed to an alert being generated. This transparency helps build trust in the system and enables more effective human-AI collaboration.

The security checkpoint system provides several advantages over traditional manual screening methods. The automated analysis of sensor data allows for continuous monitoring of the entire checkpoint area, reducing blind spots and human lapses in attention. The system can process information from multiple sensors simultaneously, enabling more comprehensive threat detection than relying on human observation alone. Machine learning models can identify subtle patterns of suspicious behavior that may not be apparent to human screeners.

The system's ability to track multiple individuals simultaneously allows for more effective monitoring of crowd dynamics and potential coordinated threats. Automated alerts reduce reaction times to potential security issues compared to relying solely on human vigilance. The collection of comprehensive data on checkpoint operations enables ongoing optimization of security procedures based on quantitative metrics.

By augmenting human security personnel with AI-powered analysis, the system allows staff to focus their attention on the highest-risk individuals and situations. This improves overall screening efficiency and effectiveness. The adaptability of the system to emerging threats provides greater long-term security compared to static screening protocols. Integration with other security databases and systems creates a more holistic view of potential risks.

The security checkpoint system has numerous potential applications beyond traditional airport security. It can be deployed in government buildings, secure office buildings, sports venues, music festivals, and other large public gatherings to enhance safety. The system could be used in border control and customs screening to identify suspicious travel patterns or smuggling attempts. Corporate facilities could employ the technology to secure sensitive areas and detect insider threats.

Schools and universities may utilize aspects of the system to enhance campus safety and prevent unauthorized access. Retail environments could adapt the technology for loss prevention and shoplifting detection. Casinos may employ similar systems to identify cheating attempts or other fraudulent activities. The core technology could be applied to analyze customer behavior patterns in various business settings.

Military installations could use the system to enhance perimeter security and control access to sensitive areas. Prisons and detention facilities may employ it to monitor inmate behavior and prevent escapes. The technology could assist in securing critical infrastructure like power plants and water treatment facilities. Public transit systems could adapt it to detect suspicious activities in stations and vehicles.

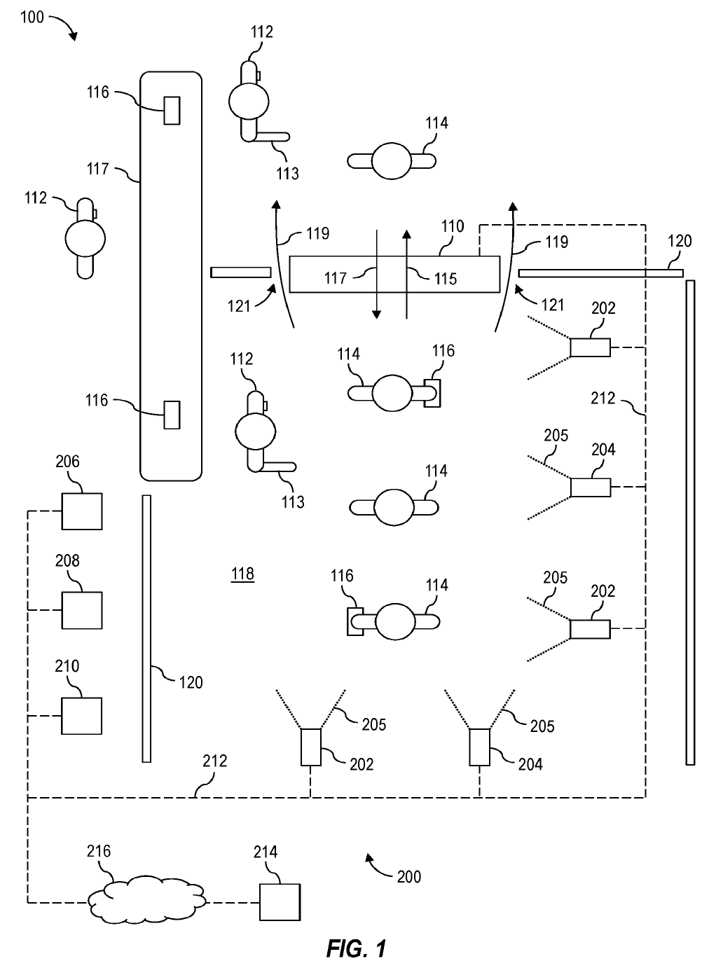

FIG. 1 is a schematic view of at least a portion of an example implementation of a security check environment 100 according to one or more aspects of the present disclosure. The security check environment 100 represents an example environment in which one or more aspects introduced in the present disclosure may be implemented. The security check environment 100 may be or comprise a security check area that can be located at entrance points of office buildings, government buildings, courthouses, mass transportation terminals (e.g., airports, train stations, bus stations, etc.), convention centers, stadiums, casinos, stores, schools, hospitals, and other buildings or spaces where security checks of human patrons are performed by prohibited object detectors and/or human security officers.

The security check environment 100 comprises a prohibited object detector 110, one or more human security officers 112, one or more human patrons 114, one or more barriers 120, one or more objects 116, and/or one or more security tables 117. The prohibited object detector 110 is operable to detect a potentially prohibited object (e.g., a metal object, a sharp object, a dense object, a large object, firearms, knives, explosives, etc.). The prohibited object detector 110 may be or comprise, for example, a metal detector, an X-ray machine, a millimeter wave scanner, a trace portal machine, frequency machine (e.g., a millimeter wave frequency machine, a wi-fi frequency machine, a terra hertz frequency machine, etc.) a radio wave signal machine, and/or a weapons detection system. The one or more human security officers 112 are stationed near the prohibited object detector 110. The one or more human patrons 114 (e.g., employees, visitors, travelers, spectators, vacationers, shoppers, students, etc.) are those who intend to walk through the prohibited object detector 110 to gain access to their intended destination. The one or more barriers 120 (e.g., fencing, railing, walls, etc.) are for limiting movement of the human patrons 114 and directing the human patrons 114 toward and through the prohibited object detector 110. The one or more objects 116 (e.g., handbags, backpack, wallets, box containers, etc.) are carried by the human patrons 114. The one or more security tables 117 are for supporting the carried objects 116 such that they can be examined by the human security officers 112. The prohibited object detector 110, the barriers 120, and the table 117 may be installed or otherwise located on a floor 118 of the security check environment 100.

During security check operations, the prohibited object detector 110 may be used to check (or scan) the human patrons 114 for prohibited objects by detecting potentially prohibited objects carried by the human patrons 114. The potentially prohibited objects may be carried openly or in a concealed manner within a carried object 116 by a human patron 114 as the human patron 114 walks through the prohibited object detector 110 (as indicated by arrow 115) to their intended destination. When the prohibited object detector 110 detects a potentially prohibited object, the prohibited object detector 110 may output an audio and/or visual alarm. In response to the alarm, a human security officer 112 may instruct the human patron 114 to walk back through the prohibited object detector 110 (as indicated by arrow 117) and then perform an additional security check of the human patron 114 and/or the object 116 carried by the human patron 114. For example, a human security officer 112 may physically check (e.g., open) the carried object 116 or physically check the human patron 114 (e.g., execute a pat down, scan with a handheld metal detector 113, request to empty pockets, etc.) in an attempt to find or otherwise identify the potentially prohibited object. When the human security officer 112 finds or identifies the potentially prohibited object, the human security officer 112 may request the human patron 114 to walk through 115 the prohibited object detector 110 again, but without the potentially prohibited object, in order to check the human patron 114 for additional potentially prohibited objects. When the human patron 114 again passes through 115 the prohibited object detector 110 and the prohibited object detector 110 does not output an audio and/or visual alarm, the human security officer 112 may then permit the human patron 114 to leave the security check environment 100 toward their intended destination.

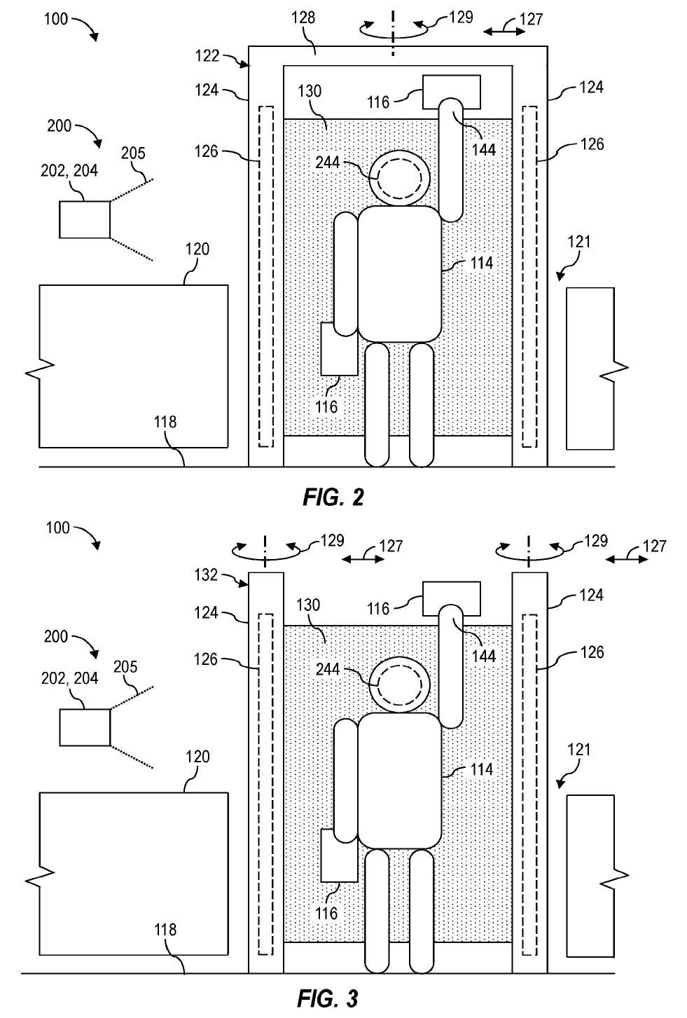

FIGS. 2 and 3 are schematic views of a portion of example implementations of the security check environment 100 shown in FIG. 1 during security check operations. Each of the FIGS. 2 and 3 show a different example implementation of a prohibited object detector 110 that may be located within the security check environment 100. Accordingly, the following description refers to FIGS. 1-3, collectively.

As shown in FIG. 2, the prohibited object detector 110 may be a single-unit (or single-structure) prohibited object detector 122 having vertical portions 124 (e.g., poles, posts, walls, members, etc.), each comprising a prohibited object detection device 126 (shown in phantom lines) operable to detect potentially prohibited objects carried by human patrons 114. The vertical portions 124 may be connected by an upper horizontal portion 128, which may maintain the vertical portions 124 at a predetermined relative separation distance. The detection devices 126 may generate a detection field (e.g., energy field) defining a prohibited object (or weapon) detection area (or space) 130 within which the prohibited object detector 122 can detect potentially prohibited objects. However, when the prohibited object detector 122 is moved linearly, as indicated by arrows 127, and/or rotated, as indicated by arrows 129, a space (or gap) 121 may be formed or become larger with respect to the barrier 120. The space 121 may permit a human patron 114 to fit through between the prohibited object detector 122 and the barrier 120, thereby bypassing (e.g., walking around) the prohibited object detector 122, as indicated in FIG. 1 by arrows 119.

As shown in FIG. 3, the prohibited object detector 110 may be a multiple-unit (or multiple-structure) prohibited object detector 132 (e.g., a portable prohibited object detector system) having two vertical portions 124 (e.g., poles, posts, walls, members, etc.) each comprising a prohibited object detection device 126 (shown in phantom lines) operable to detect potentially prohibited objects carried by human patrons 114. The vertical portions 124 may not be connected together and, thus, may be independently movable (e.g., rotatable, linearly movable) with respect to each other. Accordingly, the vertical portions 124 may be positioned at a predetermined relative separation distance and/or angle on the floor 118 by human security offices 112 or other personnel before the prohibited object detector 132 is used to detect the potentially prohibited objects. The detection devices 126 may generate a prohibited object detection area 130 within which the prohibited object detector 132 can detect the potentially prohibited objects. However, when one or more of the vertical portions 124 of the prohibited object detector 132 are moved linearly (i.e., closer together or further apart), as indicated by arrows 127, and/or rotated, as indicated by arrows 129, the detection area 130 may contract (i.e., shrink) or otherwise loose its detection effectiveness, thereby permitting a human patron 114 to carry a potentially prohibited object through the prohibited object detector 132 without detection. Furthermore, when the vertical portions 124 are moved linearly 127 and/or rotated 129, a space (or gap) 121 may be formed or become larger with respect to the barrier 120, which may permit a human patron 114 to fit between the prohibited object detector 132 and the barrier 120 and thereby bypass (e.g., walk around) the prohibited object detector 132.

The security check environment 100 may further comprise or otherwise contain a security check monitoring system 200 operable to monitor security check operations that are being performed at the security check environment 100, determine if (or when) the security check operations (e.g., checking the human patrons 114 for prohibited objects) are being performed in a suboptimal (e.g., erroneous, unintended, improper, deceitful, etc.) manner, and output an alarm indicating that the security check operations are being performed in a suboptimal manner. In other words, the monitoring system 200 may be operable to detect and provide notice of erroneous, unintended, improper, deceitful, or otherwise suboptimal actions performed by a human patron 114 and/or human security officer 112 during and/or in preparation for security check operations. For example, the monitoring system 200 may be operable to detect that: a human patron 114 is using the prohibited object detector 110 in a suboptimal (e.g., erroneous, deceitful) manner; a human security officer 112 is operating or using the prohibited object detector 110 or other security equipment in a suboptimal (e.g., erroneous, unintended, etc.) manner; a human security officer 112 is manually performing security check operations on a human patron 114 in a suboptimal (e.g., erroneous, unintended, etc.) manner; and/or the human security officer 112 is configuring the prohibited object detector 110 in a suboptimal manner for use during security check operations.

The monitoring system 200 may comprise one or more sensors 202, 204, an alert output device 206, a processing device 208, and a control workstation 210. The sensors 202, 204, the output device 206, the processing device 208, and the control workstation 210 may be communicatively connected via wired and/or wireless communication means 212 (shown in phantom lines).

The sensors 202, 204 may be operable to output sensor data indicative of physical characteristics of one or more portions of the security check environment 100. Each of the sensors 202, 204 may comprise a field of view 205 that is directed toward a predetermined one or more portions of the security check environment 100, including the prohibited object detector 110, one or more of the human security officers 112, one or more of the human patrons 114, one or more of the carried objects 116, and/or the table 117 supporting the carried objects 116. The physical characteristics of the security check environment 100 that may be indicated by the sensor data output by the sensors 202, 204 may include, for example, distance (i.e., actual position or depth) of one or more portions of the security check environment 100, relative distance (or position) between one or more portions of the security check environment 100, a movement path (or direction) of one or more portions of the security check environment 100, size of one or more portions of the security check environment 100, and/or shape of one or more portions of the security check environment 100. The sensors 202, 204 may include one or more digital video cameras 202. The sensors 202, 204 may also or instead include one or more ranging devices 204 operable to determine distance (or location) of objects. The ranging devices 204 may be or comprise, for example, light detection and ranging devices (LIDARs) and/or sound (e.g., ultrasound, sonar, etc.) detection and ranging devices.

The alert output device 206 (e.g., display screen, a light, an audio speaker, etc.) may be operable to output a signal, such as an audio signal (e.g., an alarm) and/or a visual signal (e.g., a light, text, etc.), indicating to the human security officers 112 that the security check operations are being performed in a suboptimal manner. The output signal may describe or otherwise indicate to the human security officers 112 how the security check operations are being performed in a suboptimal manner. For example, the alert output device 206 may display text describing or otherwise indicating how the security check operations are being performed in a suboptimal manner.

The prohibited object detector 110 may also be communicatively connected to the monitoring system 200 via the communication means 212. The communicative connection may permit the processing device 208 and/or the control workstation to 210 to receive and monitor operational settings data and/or operational status data indicative of operational settings and operational status, respectively, of the prohibited object detector 110. The communicative connection may further permit the processing device 208 and/or the control workstation 210 to transmit control data to the prohibited object detector 110, such as to control operational settings and/or operational status of the prohibited object detector 110.

The processing device 208 (e.g., a controller, a programmable logic controller (PLC), a computer, etc.) may be operable to monitor operational performance of and provide control to one or more portions of the monitoring system 200 and/or the prohibited object detector 110. The processing device 208 may be operable to receive and process sensor data output by the sensors 202, 204 and output control data (i.e., control commands) to one or more portions of the monitoring system 200 and/or the prohibited object detector 110 to perform various operations described herein based on the sensor data. The processing device 208 may comprise a processor and a memory storing an executable computer program code, instructions, and/or operational parameters or set-points, including for implementing one or more aspects of methods and operations described herein. For example, execution of the computer program code by the processor may cause the processing device 208 to receive the sensor data output by the sensors 202, 204, determine if (or when) the security check operations are being performed in a suboptimal manner based on the sensor data, and, when the security check operations are being performed in a suboptimal manner, output alarm data to the output device 206 to cause the output device 206 to output an alarm signal indicative of the suboptimal manner in which the security check operations are being performed. When the security check operations are being performed in a suboptimal manner, the processing device 208 may output alarm data to the output device 206 to cause the output device 206 to output information (e.g., an audio message, a textual message, etc.) indicative of the optimal manner in which the security check operations are to be performed by the human security officers 112 and/or the human patrons 114. For example, the output device 206 may output information indicating how the human security officers 112 should check the human patrons 114 for prohibited objects. The output device 206 may also or instead output information indicating how the human patrons 114 should walk through the prohibited object detector 110. During or after the security check operations, the processing device 208 may also record the sensor data output by the sensors 202, 204 and/or data indicative of whether the security check operations are being performed in a suboptimal manner.

The control workstation 210 (i.e., a human-machine interface (HMI)) may be communicatively connected with the processing device 208, the sensors 202, 204, and/or the prohibited object detector 110 via the communication means 212, such as may permit the control workstation 210 to be used to control operational performance and/or settings of the processing device 208, the sensors 202, 204, and/or the prohibited object detector 110. The control workstation 210 may comprise one or more input devices (i.e., control devices) usable by a human security officer 112 to control the processing device 208, the sensors 202, 204, and/or the prohibited object detector 110. The input devices may comprise, for example, a joystick, a mouse, a keyboard, a touchscreen, and/or other input devices. The control workstation 210 may also comprise one or more output devices operable to visually and/or audibly show or otherwise indicate to the human security officer 112 status of the processing device 208, the sensors 202, 204, and/or the prohibited object detector 110. The output devices may comprise, for example, a gauge, a video monitor, a touchscreen, a light, an audio speaker, etc.).

The monitoring system 200 may further comprise a remote processing device 214 (e.g., a computer, a server, a database, etc.) communicatively connected with the sensors 202, 204, the processing device 208, and/or the control workstation 210. During or after the security check operations, the processing device 208 may transmit the sensor data output by the sensors 202, 204, the data indicative of whether the security check operations are being performed in a suboptimal manner, and/or other data output by the processing device 208 and/or the control workstation 210 to the remote processing device 214 for real-time analysis, recordation, and/or subsequent further analysis. The remote processing device 214 may be located outside of the security check environment 100, such as in a different room, a different building, or a different city. The remote processing device 214 may be accessible via a communication network 216, such as a local area network (LAN), a wide area network (WAN), a cellular network, or the internet.

During security check operations, the processing device 208 may generate a three-dimensional (or spatial) digital map (or image) of the security check environment 100 based on the sensor data output by one or more of the sensors 202, 204, and determine if the security check operations are being performed in a suboptimal manner based on the three-dimensional digital map. For example, the processing device 208 may generate a three-dimensional digital map of the security check environment 100 based on sensor data output by one or more of the sensors 202, 204 (e.g., at least one of the digital video cameras 202 and at least one of the ranging devices 204). The three-dimensional digital map may be indicative of, for example, distance (i.e., actual position or depth) of one or more portions of the security check environment 100, relative distance (or position) between one or more portions of the security check environment 100, movement path (e.g., direction) of one or more portions of the security check environment 100, size of one or more portions of the security check environment 100, and/or shape of one or more portions of the security check environment 100.

The three-dimensional digital map of the security check environment 100 may comprise digital models of various portions of the security check environment 100, which may include the prohibited object detector 110, the security table 117, one or more human security officers 112, one or more human patrons 114, and one or more carried objects 116 carried by the human patrons 114. The processing device 208 may analyze the digital models of the security check environment 100 to recognize and determine physical characteristics of predetermined portions of the security check environment 100, such as, for example, distance (i.e., actual position or depth) of one or more portions of the security check environment 100, relative distance (or position) between one or more portions of the security check environment 100, movement path (e.g., direction) of one or more portions of the security check environment 100, size of one or more portions of the security check environment 100, and/or shape of one or more portions of the security check environment 100.

In an example implementation of the monitoring system 200, the ranging devices 204 may output sensor data comprising digital position points (or dots) indicative of depth (or distance) of various portions of the security check environment 100. The processing device 208 may track position (or location) and movement of the digital position points. The processing device 208 may recognize the digital position points associated with predetermined portions of the security check environment 100. By tracking the digital position points, the processing device 208 can stich the sensor data output by the video cameras 202 and the sensor data output by the ranging devices 204 to facilitate tracking of position and movement of the predetermined portions of the security check environment 100 with high accuracy (e.g., 99% when the sensors 202, 204 are within 6.1 meters (20 feet) of the predetermined portions of the security check environment 100).

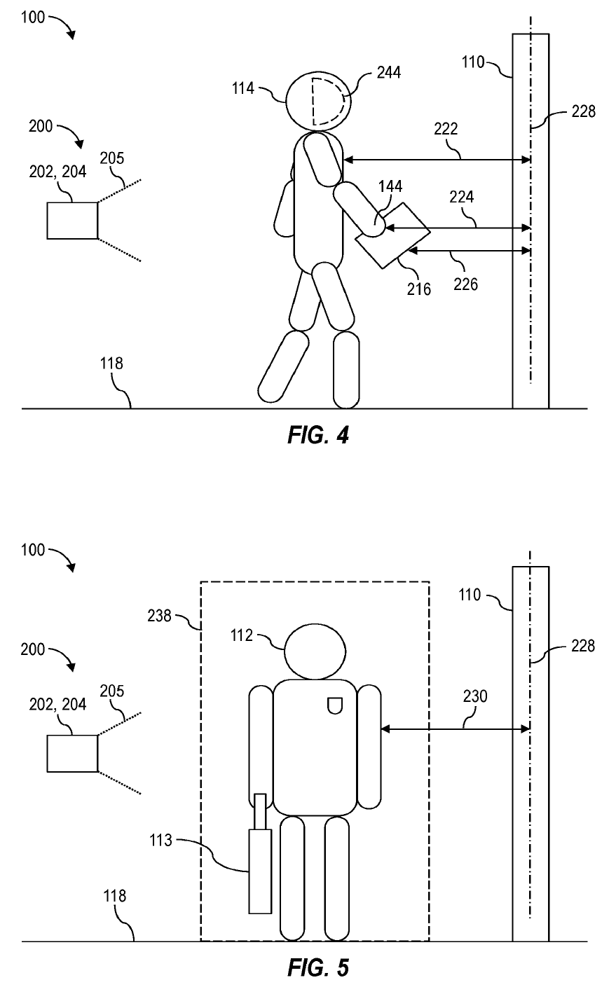

FIGS. 2-4 are schematic views of a portion of the security check environment 100 shown in FIG. 1 during security check operations when the monitoring system 200 is being used to determine if (or when) the security check operations are being performed in a suboptimal manner. Accordingly, the following description refers to FIGS. 1-4, collectively.

During security check operations, the processing device 208 may determine (or measure) a position 222 of a human patron 114, a position 224 of a portion (e.g., a hand 144) of a human patron 114, and/or a position 226 of an object 116 carried by the human patron 114 based on sensor data associated with the human patron 114 (e.g., the digital model of the human patron 114). Such positions 222, 224, 226 may be determined relative to (with respect to) a position 228 of the prohibited object detector 110 based on sensor data associated with the human patron 114 and the prohibited object detector 110 (e.g., the digital model of the human patron 114 and the digital model of the prohibited object detector 110).

The processing device 208 may be further operable to determine a movement path 222 (e.g., direction) of a human patron 114, a movement path 224 of a portion (e.g., a hand 144) of a human patron 114, and/or a movement path 226 of an object 116 carried by a human patron 114 based on sensor data associated with the human patron 114 (e.g., the digital model of the human patron 114). Such movement paths 222, 224, 226 may be determined relative to (with respect to) the position 228 of the prohibited object detector 110 based on sensor data associated with the human patron 114 and the prohibited object detector 110 (e.g., the digital model of the human patron 114 and the digital model of the prohibited object detector 110).

For example, the processing device 208 may be operable to recognize the prohibited object detector 110 in the three-dimensional digital map, recognize a human patron 114 in the three-dimensional digital map, and determine one or more of the positions 222, 224, 226 and/or movement paths 222, 224, 226 with respect to the position 228 of the prohibited object detector 110 based on the three-dimensional digital map. The processing device 208 may be further operable to then determine if the security check operations are being performed in a suboptimal manner based on the determined positions 222, 224, 226 and/or movement paths 222, 224, 226 with respect to the prohibited object detector 110.

Accordingly, the processing device 208 may determine that the security check operations are being performed in a suboptimal manner based on suboptimal (e.g., erroneous, unintended, improper, deceitful, etc.) actions by a human patron 114, such as, for example, when: the human patron 114 walks around 119 and not through the prohibited object detector 110; the human patron 114 walks through 115 the prohibited object detector 110 while carrying an object 116 through the prohibited object detector 110 (as shown in FIGS. 2-4); the human patron 114 walks through 115 the prohibited object detector 110 while positioning at least one hand 144 outside of (e.g., above) the prohibited object detector 110 (as shown in FIGS. 2 and 3); the human patron 114 walks through 115 the prohibited object detector 110 while carrying the object 116 outside of the prohibited object detector 110 (as shown in FIGS. 2 and 3); the human patron 114 walks through 115 the prohibited object detector 110 while positioning at least one hand 144 outside of (e.g., above) the prohibited object detection area 130 of the prohibited object detector 110 (as shown in FIGS. 2 and 3); the human patron 114 walks through 115 the prohibited object detector 110 while carrying the object 116 outside of the prohibited object detection area 130 of the prohibited object detector 110 (as shown in FIGS. 2 and 3); after the human patron 114 walks through 115 the prohibited object detector 110 and the prohibited object detector 110 detects the potentially prohibited object, the human patron 114 fails to walk back 117 through the prohibited object detector 110; and/or after the human patron 114 walks through 115 the prohibited object detector 110 and the prohibited object detector 110 detects the potentially prohibited object, the human patron 114 fails to present the potentially prohibited object to the human security officer 112.

During security check operations, the processing device 208 may analyze the sensor data associated with human patrons 114 (e.g., the digital model of the human patron 114) to detect (i.e., perform facial recognition operations) facial features 244 (shown in phantom lines) of the human patrons 114. The processing device 208 may be further operable to compare the facial features 244 of the human patrons 114 to facial features of human criminals (e.g., terrorists) stored on the processing device 208, the remote processing device 214, or a third party (e.g., a federal government) remote processing device (not shown). When the facial features 244 of a human patron 114 match facial features of a human criminal, the processing device 208 may output alarm data to the output device 206 to cause the output device 206 to output an alarm signal indicative of such match.

FIGS. 5-7 are schematic views of a portion of the security check environment 100 shown in FIGS. 1-4 during security check operations when the monitoring system 200 is being used to determine if the security check operations are being performed in a suboptimal manner. Accordingly, the following description refers to FIGS. 1-7, collectively.

As shown in FIG. 5, during security check operations, the processing device 208 may determine a position (or distance) 230 and/or a movement path (or direction) 230 of a human security officer 112 relative to the prohibited object detector 110 based on sensor data associated with the human security officer 112 and the position 228 of the prohibited object detector 110 (e.g., the digital model of the human security officer 112 and the prohibited object detector 110).

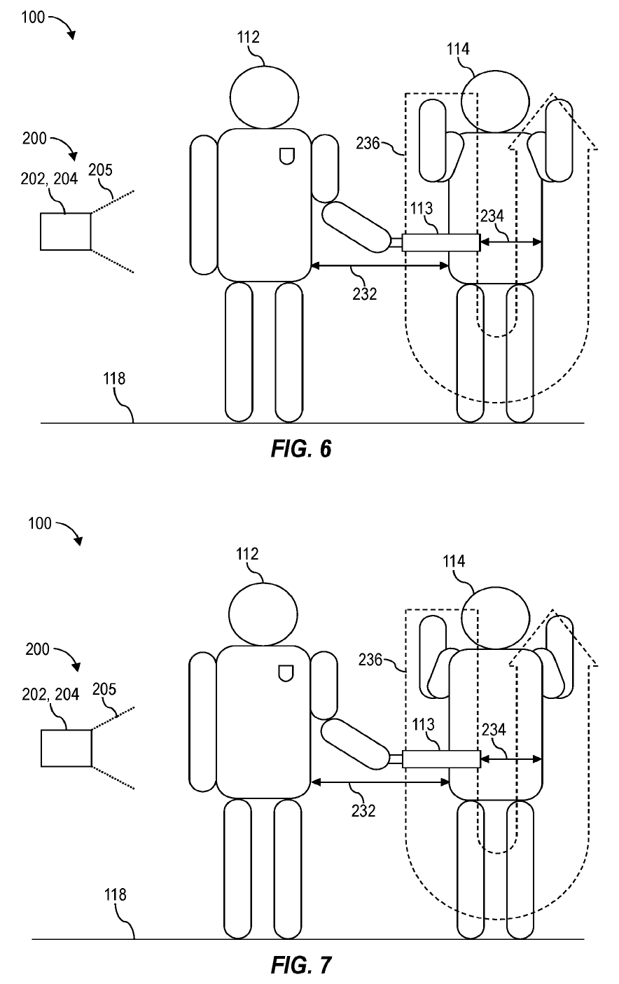

As shown in FIGS. 6 and 7, during security check operations, the processing device 208 may determine a position (or distance) 232 of a human security officer 112 or a position 234 of a portion (e.g., an arm, a handheld metal detector 113, etc.) of the human security officer 112 relative to (with respect to) a human patron 114 based on sensor data associated with the human security officer 112 and the human patron 114 (e.g., the digital model of the human security officer 112 and the digital model of the human patron 114). The processing device 208 may be further operable to determine a path (e.g., a direction) 232 of movement of a human security officer 112 or a path 236 of movement of a portion (e.g., an arm, a handheld metal detector 113, etc.) of the human security officer 112 relative to (with respect to) a human patron 114 based on sensor data associated with the human security officer 112 and the human patron 114 (e.g., the digital model of the human security officer 112 and the digital model of the human patron 114). The processing device 208 may then determine if the security check operations are being performed in a suboptimal manner based on the determined relative positions 232, 234 and/or movement paths 232, 236. Accordingly, the processing device 208 may determine that the security check operations are being performed in a suboptimal manner based on suboptimal (e.g., erroneous, unintended, improper, etc.) actions by a human security officer 112, such as, for example, when the human security officer 112 fails to check the human patron 114 for a potentially prohibited object using a predetermined check procedure.

An example predetermined check procedure to check a human patron 114 for a potentially prohibited object may include checking the human patron 114 for a potentially prohibited object using a handheld metal detector (or wand) 113 in a correct or otherwise predetermined manner, such as when the prohibited object detector 110 detects a potentially prohibited object on the human patron 114. Such predetermined manner of using the handheld metal detector 113 may include moving the handheld metal detector along a U-shaped path (or motion) 236 along the body of the human patron 114. The predetermined manner of using the handheld metal detector 113 may be the “U-Shaped Screening Technique” defined in the Department of Homeland Security guide, which includes security steps such as: instructing the patron (e.g., the human patron 114) to remove all metal items from his or her pockets and hold the items (e.g., carried objects 116) at shoulder height with elbows at his or her sides; inspecting the items in the patron’s hands; instructing the patron to stand with their feet shoulder width apart; screening the patron with the handheld metal detector starting in front of the patron at the top right shoulder area; moving the handheld metal detector down the front of the patron to the right foot; moving to the left foot; bringing the handheld metal detector up to the top left shoulder area in a U-shaped motion; instructing the patron to turn around; repeating the U-shaped motion; if an alarm sounds, stop screening and proceed with a limited pat-down of the area in question; and then rescreen the area again to make sure it is clear.

The processing device 208 may determine that the security check operations are being performed in a suboptimal manner also based on lack of predetermined actions (or nonactions) by a human security officer 112, such as, for example, when: the human security officer 112 fails to check a human patron 114 for a potentially prohibited object; and/or the human security officer 112 fails to check contents of (e.g., open) an object 116 (e.g., a handbag) carried by the human patron 114 for potentially prohibited objects.

As shown in FIG. 5, the processing device 208 may determine that the security check operations are being performed in a suboptimal manner also based on lack of other predetermined actions by a human security officer 112, such as when the human security officer 112 fails to maintain a predetermined post (e.g., station, position, distance, etc.) at the security check environment 100. The human security officer 112 fails to maintain a predetermined post at the security check environment 100, for example, when: the human security officer 112 is not stationed at his/her station 238 (e.g., behind the table 117, next to the prohibited object detector 110, etc.) for more than a predetermined period of time; the human security officer 112 is not within a predetermined distance 230 of or otherwise with respect to the prohibited object detector 110 for more than a predetermined period of time; and/or the human security officer 112 is busy dealing with a security incident for more than a predetermined period of time.

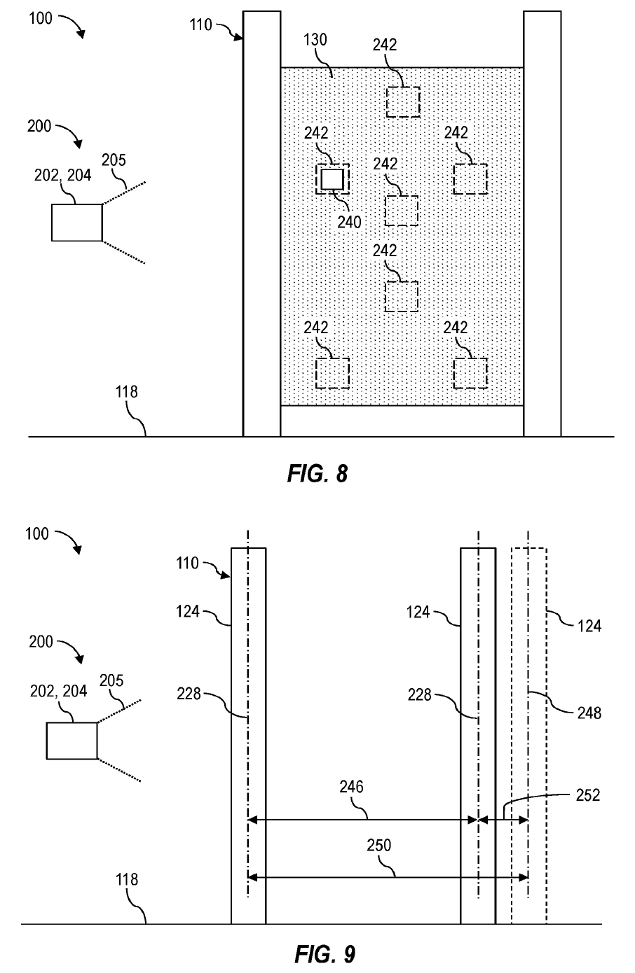

As shown in FIG. 8, the processing device 208 may determine that the security check operations are being performed in a suboptimal manner also based on lack of still other predetermined actions (or nonactions) by a human security officer 112, such as, for example, when: the human security officer 112 fails to test operation of the prohibited object detector 110 at a predetermined time (e.g., every four hours, every morning, once a week, etc.); and/or the human security officer 112 fails to test operation of the prohibited object detector 110 using a predetermined test procedure. An example predetermined test procedure for testing operation of the prohibited object detector 110 may include testing detection functionality of the prohibited object detector 110 by moving a test prohibited object 240 along a plurality of test paths 242 (each shown in phantom lines) through the detection area 130 of the prohibited object detector 110. The test paths 242 may include three test paths (each at a different height) on the left side of the detection area 130, three test paths (each at a different height) on the right side of the detection area 130, and three test paths (each at a different height) through the middle of the detection area 130. To test the functionality of the prohibited object detector 110, the processing device 208 may indicate to human security officer 112 or other personnel, via the control workstation 210 and/or the output device 206, to move the test prohibited object 240 along the predetermined plurality of test paths 242 through the detection area 130 of the prohibited object detector 110 while the processing device 208 receives and analyzes the sensor data output by one or more of the sensors 202, 204. The processing device 208 may then determine if the test prohibited object 240 is carried by a human (e.g., a human security officer 112) along each of the predetermined plurality of test paths 242 through the detection area 130 of the prohibited object detector 110. The processing device 208 may then receive from the prohibited object detector 110, via the communication means 212, detection data indicative of whether the prohibited object detector 110 detected the test prohibited object 240 during each movement (or pass) through the detection area 130. The processing device 208 may also or instead receive the detection data that is input manually into the processing device 208 via the control workstation 210 by a human security officer 112. The human security officer 112 performing the test procedure may also enter into the processing device 208 contextual data indicative of, for example: identity of the human security officer 112 performing the test; date of the test procedure; time of the test procedure; whether the prohibited object detector 110 successfully detected the test prohibited object 240 during each movement through the detection area 130; whether the prohibited object detector 110 did not successfully detect the test prohibited object 240 during each movement through the detection area 130; and/or how the human security officer 112 changed the operational settings of the prohibited object detector 110 such that the prohibited object detector 110 eventually successfully detected the test prohibited object 240 during each movement through the detection area 130. The processing device 208 may record the detection data and the contextual data entered during the testing operations, and/or the processing device 208 may transmit such data to the remote processing device 214 for real-time analysis, recordation, and subsequent further analysis.

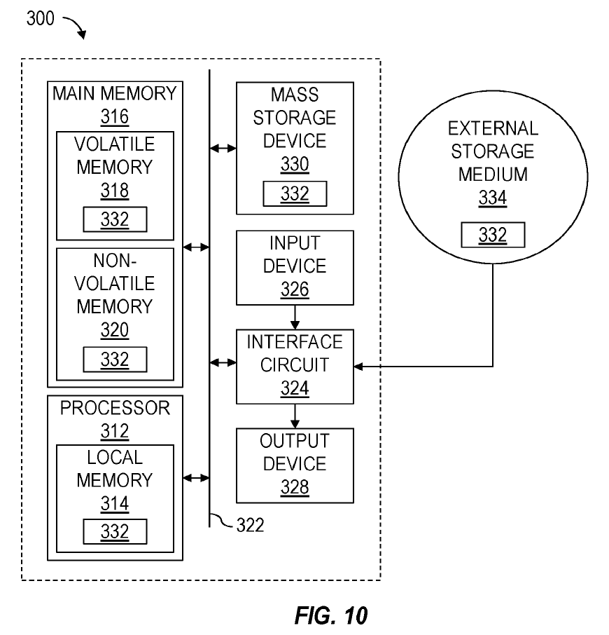

FIG. 9 is still another schematic view of a portion of the security check environment 100 shown in FIGS. 1-8 during security check operations when the monitoring system 200 is being used to determine if the security check operations are being performed in a suboptimal manner. Accordingly, the following description refers to FIGS. 1-9, collectively.

As shown in FIG. 9, during security check operations, the processing device 208 may determine (or measure) a position (i.e., an actual position) of the prohibited object detector 110 based on sensor data associated with the prohibited object detector 110 (e.g., the digital model of the prohibited object detector 110) output by the sensors 202, 204. The actual position of the prohibited object detector 110 may comprise: an actual position 228 (e.g., a linear position or an angular position) of the whole prohibited object detector 110; an actual position 228 (e.g., a linear position or an angular position) of a predetermined portion 124 (e.g., pole, post, wall, member, etc.) of the prohibited object detector 110; and/or an actual distance 246 (e.g., a linear distance or an angular distance) between predetermined portions 124 (e.g., poles, posts, walls, members, etc.) of the prohibited object detector 110 (e.g., a metal detector). The processing device 208 may then determine a position difference 252 (e.g., a linear position difference or an angular position difference) between the actual position of the prohibited object detector 110 and an intended position of the prohibited object detector 110. The intended position of the prohibited object detector 110 may comprise an intended position 248 (e.g., an intended linear position or an intended angular position) of the whole prohibited object detector 110; an intended position 248 (e.g., an intended linear position or an intended angular position) of a predetermined portion 124 (e.g., pole, post, wall, member, etc.) of the prohibited object detector 110; and/or an intended distance 250 (e.g., an intended linear distance or an intended angular distance) between predetermined portions 124 (e.g., poles, posts, walls, members, etc.) of the prohibited object detector 110 (e.g., a metal detector). The processing device 208 may then determine that the prohibited object detector 110 is used in a suboptimal manner to detect the potentially prohibited object when the position difference 252 is greater than a predetermined threshold. When the position difference 252 is greater than the predetermined threshold, the processing device 208 may then output alarm data to the output device 206 to cause the output device 206 to output an alarm signal indicative of: the actual position of the prohibited object detector 110; and/or the position difference 252 between the actual position of the prohibited object detector 110 and an intended position 248 of the prohibited object detector 110. The alarm data may also or instead cause the output device 206 to output an alarm signal indicative of mere existence of the position difference 252, such as a light or text indicating that one or more portions 124 are not located at intended positions 248 or are otherwise not positioned as intended. The alarm signal may also or instead instruct the human security officers 112 to check the physical setup (or relative distances) of the predetermined portions 124 of the prohibited object detector 110.

During security check operations, the processing device 208 may, thus, determine (or measure) the distance 246 between predetermined portions 124 (e.g., poles, posts, walls, members, etc.) of the prohibited object detector 110 based on the sensor data (e.g., a digital model of the prohibited object detector 110). The processing device 208 may then determine that the security check operations are being performed in a suboptimal manner to detect the potentially prohibited object when the determined distance 246 is greater than a maximum predetermined distance between the predetermined portions 124 of the prohibited object detector 110 or less than a minimum predetermined distance between the predetermined portions of the prohibited object detector 110.

During or after the security check operations, the processing device 208 may transmit the sensor data output by the sensors 202, 204, the data indicative of whether the security check operations are being performed in a suboptimal manner, and/or other data output by the processing device 208 to other devices. For example, the processing device 208 may transmit such data to the output device 206 and/or the control workstation 210 to alert or otherwise notify the human security officers 112 in real-time that the security check operations are being performed in a suboptimal manner. The processing device 208 may also or instead transmit such data to the remote processing device 214 to alert or otherwise notify other human security personnel in real-time that the security check operations are being performed in a suboptimal manner, to record the data, and/or for subsequent analysis. The processing device 208 may also or instead transmit such data to a mobile device (e.g., a laptop, a cellular phone, etc.) to alert or otherwise notify the human security officers 112 and/or other human security personnel in real-time that the security check operations are being performed in a suboptimal manner, to record the data, and/or for subsequent analysis. The output device 206, the control workstation 210, the remote processing device 214, and/or the mobile device may output an audio and/or visual alarm indicating to the human security officers 112 and/or other human security personnel in real-time: that the security check operations are being performed in a suboptimal manner; how the security check operations are being performed in a suboptimal manner; and/or the corrective course of action that the human security officers 112 and/or other human security personnel can take such that the security check operations will be performed in an optimal manner.

The monitoring system 200 may be further operable to control operation of the prohibited object detector 110 based on the determination that the prohibited object detector 110 is being operated in a suboptimal manner. For example, the processing device 208 of the monitoring system 200 may be operable to control operation of a prohibited object detector 110 based on the determination that the prohibited object detector 110 is being used to detect a potentially prohibited object in a suboptimal manner during security check operations. The processing device 208 of the monitoring system 200 may also or instead be operable to control (e.g., adjust or configure) operation of the prohibited object detector 110 based on the determination that the prohibited object detector 110 is being tested (or configured) in a suboptimal manner during testing operations. Thus, if (or when) the processing device 208 of the monitoring system 200 determines, based on the sensor data, that the security check operations and/or the testing operations at the security check environment 100 are being performed in a suboptimal manner, the processing device 208 may output control data to the prohibited object detector 110 to control operation of the prohibited object detector 110. Control data output by the processing device 208 may be indicative of operational setting of the prohibited object detector 110. Operational setting of the prohibited object detector 110 may include, for example, adjustments to: sensitivity to detect potentially prohibited objects by the prohibited object detection device 126 of the prohibited object detector 110; geometric dimensions (e.g., shape, size, height, etc.) of the detection field defining the prohibited object detection area (or space) 130; and/or characteristics (e.g., frequency, wavelength, intensity, etc.) of the detection field.

For example, the processing device 208 may output control data to the prohibited object detector 110 to control operation of the prohibited object detector 110 if (or when) the processing device 208 detects or otherwise determines that: a human patron 114 carries an object 116 through the prohibited object detector 110 and the prohibited object detector 110 does not detect a potentially prohibited object and, thus, does not output an audio/visual alarm; the human patron 114 walks through the prohibited object detector 110 while positioning at least one hand 144 outside of the prohibited object detector 110; the human patron 114 walks through the prohibited object detector 110 while carrying an object 116 outside of the prohibited object detector 110; the human patron 114 walks through the prohibited object detector 110 while positioning at least one hand 144 outside of the detection area 130 of the prohibited object detector 110; the human patron 114 walks through the prohibited object detector 110 while carrying an object 116 outside of the detection area 130; a human security officer 112 fails to check the human patron 114 for prohibited objects using a predetermined check procedure; the human security officer 112 fails to test operation of the prohibited object detector 110 at a predetermined time; the human security officer 112 fails to test operation of the prohibited object detector 110 using a predetermined test procedure; and/or the human security officer 112 carries a test prohibited object 240 through the prohibited object detector 110 and the prohibited object detector 110 does not detect the test prohibited object.

FIG. 10 is a schematic view of at least a portion of an example implementation of a processing device 300 (or system) according to one or more aspects of the present disclosure. The processing device 300 may be or form at least a portion of one or more electronic devices shown in one or more of FIGS. 1-9. Accordingly, the following description refers to FIGS. 1-10, collectively.

The processing device 300 may be or comprise, for example, one or more processors, controllers, special-purpose computing devices, PCs (e.g., desktop, laptop, and/or tablet computers), personal digital assistants, smartphones, IPCs, PLCs, servers, internet appliances, and/or other types of computing devices. The processing device 300 may be or form at least a portion of the processing devices 208, 214 and the control workstation 210 of the monitoring system 200. The processing device 300 may also be or form at least a portion of the prohibited object detector 110 of the security check environment 100. Although it is possible that the entirety of the processing device 300 is implemented within one device, it is also contemplated that one or more components or functions of the processing device 300 may be implemented across multiple devices, some or an entirety of which may be at the security check environment 100 and/or remote from the security check environment 100.

The processing device 300 may comprise a processor 312, such as a general-purpose programmable processor. The processor 312 may comprise a local memory 314, and may execute machine-readable and executable program code instructions 332 (i.e., computer program code) present in the local memory 314 and/or other memory devices. The processor 312 may execute, among other things, the program code instructions 332 and/or other instructions and/or programs to implement the example methods and/or operations described herein. For example, the program code instructions 332, when executed by the processor 312 of the processing device 300, may cause the processor 312 to receive and process: sensor data (e.g., sensor measurements) output by the sensors 202, 204; and/or operational settings and/or operational status data output by the prohibited object detector 110. The program code instructions 332, when executed by the processor 312 of the processing device 300, may also or instead output control data (or control commands) to cause one or more portions of the monitoring system 200 (e.g., the sensors 202, 204, the output device 206, etc.) and/or the security check environment 100 (e.g., the prohibited object detector 110) to perform the example methods and/or operations described herein. The processor 312 may be, comprise, or be implemented by one or more processors of various types suitable to the local application environment, and may include one or more of general-purpose computers, special-purpose computers, microprocessors, digital signal processors (DSPs), field-programmable gate arrays (FPGAs), application-specific integrated circuits (ASICs), and processors based on a multi-core processor architecture, as non-limiting examples. Examples of the processor 312 include one or more INTEL microprocessors, microcontrollers from the ARM, PIC, and/or PICO families of microcontrollers, embedded soft/hard processors in one or more FPGAs.

The processor 312 may be in communication with a main memory 316, such as may include a volatile memory 318 and a non-volatile memory 320, perhaps via a bus 322 and/or other communication means. The volatile memory 318 may be, comprise, or be implemented by random access memory (RAM), static random-access memory (SRAM), synchronous dynamic random-access memory (SDRAM), dynamic random-access memory (DRAM), RAMBUS dynamic random-access memory (RDRAM), and/or other types of random-access memory devices. The non-volatile memory 320 may be, comprise, or be implemented by read-only memory, flash memory, and/or other types of memory devices. One or more memory controllers (not shown) may control access to the volatile memory 318 and/or non-volatile memory 320.

The processing device 300 may also comprise an interface circuit 324, which is in communication with the processor 312, such as via the bus 322. The interface circuit 324 may be, comprise, or be implemented by various types of standard interfaces, such as an Ethernet interface, a universal serial bus (USB), a third-generation input/output (3GIO) interface, a wireless interface, a cellular interface, and/or a satellite interface, among others. The interface circuit 324 may comprise a graphics driver card. The interface circuit 324 may comprise a communication device, such as a modem or network interface card to facilitate exchange of data with external computing devices via a network (e.g., Ethernet connection, digital subscriber line (DSL), telephone line, coaxial cable, cellular telephone system, satellite, etc.).

The processing device 300 may be in communication with various sensors, video cameras, actuators, processing devices, equipment controllers, and other devices of the monitoring system 200 and/or the security check environment 100 via the interface circuit 324. The interface circuit 324 can facilitate communications between the processing device 300 and one or more devices by utilizing one or more communication protocols, such as an Ethernet-based network protocol (such as ProfiNET, OPC, OPC/UA, Modbus TCP/IP, EtherCAT, UDP multicast, Siemens S7 communication, or the like), a proprietary communication protocol, and/or another communication protocol.

One or more input devices 326 may also be connected to the interface circuit 324. The input devices 326 may permit human users (e.g., human security officers 112) to enter the program code instructions 332, which may be or comprise control commands, operational parameters, physical properties, and/or operational set-points. The program code instructions 332 may further comprise modeling or predictive routines, equations, algorithms, processes, applications, and/or other programs operable to perform example methods and/or operations described herein. The input devices 326 may be, comprise, or be implemented by a keyboard, a mouse, a joystick, a touchscreen, a trackpad, a trackball, an isopoint, and/or a voice recognition system, among other examples. One or more output devices 328 may also be connected to the interface circuit 324. The output devices 328 may permit visualization or other sensory perception of various data, such as sensor data, status data, contextual data, and/or other example data. The output devices 328 may be, comprise, or be implemented by video output devices (e.g., an LCD, an LED display, a CRT display, a touchscreen, etc.), printers, and/or speakers, among other examples. The one or more input devices 326 and the one or more output devices 328 connected to the interface circuit 324 may, at least in part, facilitate the HMI devices described herein.

The processing device 300 may comprise a mass storage device 330 for storing data and program code instructions 332. The mass storage device 330 may be connected to the processor 312, such as via the bus 322. The mass storage device 330 may be or comprise a tangible, non-transitory storage medium, such as a floppy disk drive, a hard disk drive, a compact disk (CD) drive, and/or digital versatile disk (DVD) drive, among other examples. The processing device 300 may be communicatively connected with an external storage medium 334 via the interface circuit 324. The external storage medium 334 may be or comprise a removable storage medium (e.g., a CD or DVD), such as may be operable to store data and program code instructions 332.

As described above, the program code instructions 332 may be stored in the mass storage device 330, the main memory 316, the local memory 314, and/or the removable storage medium 334. Thus, the processing device 300 may be implemented in accordance with hardware (perhaps implemented in one or more chips including an integrated circuit, such as an ASIC), or may be implemented as software or firmware for execution by the processor 312. In the case of firmware or software, the implementation may be provided as a computer program product including a non-transitory, computer-readable medium or storage structure embodying computer program code instructions 332 (i.e., software or firmware) thereon for execution by the processor 312. The program code instructions 332 may include program instructions or computer program code that, when executed by the processor 312, may perform and/or cause performance of example methods, processes, and/or operations described herein.

For example, the program code instructions 332 stored on one or more of the memories 318, 320, 314, 330, 334 of the processing device 300 may comprise object recognition (i.e., vision) software, which when executed by the processor 312 of the processing device 300 may cause the processing device 300 to receive and analyze (i.e., process) the sensor data generated by the sensors 202, 204 to recognize predetermined portions of the security check environment 100. In an example implementation, the object recognition software, which when executed by the processor 312 of the processing device 300 may cause the processing device 300 to generate a three-dimensional digital map of the security check environment 100 comprising digital models of the recognized predetermined portions of the security check environment 100. The processing device 300 may then determine physical characteristics of the recognized predetermined portions of the security check environment 100, as described herein.

The program code instructions 332 stored on one or more of the memories 318, 320, 314, 330, 334 of the processing device 300 may also or instead utilize or comprise aspects of artificial intelligence (AI) (including machine learning) to analyze the sensor data generated by the sensors 202, 204 to recognize predetermined portions (e.g., the prohibited object detector 110, the human security officers 112, the human patrons 114, etc.) of the security check environment 100 and then determine physical characteristics (e.g., positions and/or movements) of the recognized predetermined portions of the security check environment 100, as described herein. The processing device 300 may be operable to generate (i.e., train or teach) an AI model of the security check environment 100 by processing or otherwise based on labeled sensor data indicative of or otherwise associated with: positions and/or movements of various equipment of the security check environment 100, positions and/or movements of the human security officers 112; and/or positions and/or movements of the human patrons 114.

In certain embodiments in which the prohibited object detector 110 is an x-ray machine (or similar device), it may be desirable to provide the images scanned by the detector 110 to an AI that has been trained to recognize prohibited objects in images. The AI may then analyze x-ray scan data generated by x-ray scanning equipment within the security check environment 100. This AI-powered analysis is designed to detect and recognize prohibited objects within scanned items, such as luggage, bags, or packages. The processing device 300 may be operable to generate and continuously refine an AI model specifically trained on a diverse dataset of x-ray images containing various prohibited items, including weapons, explosives, and other restricted materials. This model can be regularly updated to account for new threat types or concealment methods, ensuring the system maintains its effectiveness against evolving security risks.

When the AI system detects a potential prohibited object within an x-ray scan, it can trigger a range of customizable alerts. These alerts may be local, such as activating a visual indicator on the x-ray machine's display or sounding an audible alarm at the checkpoint. Alternatively, or in addition, the system can generate remote alerts, sending notifications to security personnel mobile devices or to a centralized security operations center. The nature of these alerts can be tailored to the specific needs of the security environment, with options for silent alerts to avoid causing panic in crowded areas, or more overt warnings in high-security zones. The AI system's ability to quickly and accurately process x-ray scans enhances the overall efficiency of the security screening process, potentially reducing wait times while maintaining or improving detection rates for prohibited items.

In certain embodiments, it may be desirable to implement a "man-in-the-middle" approach to enhance the efficiency and accuracy of threat detection. This architecture would permit the on-site personnel to focus on alerts generated by both the walkthrough system and the X-ray scanner, streamlining their role. By narrowing the focus to only those items flagged by the AI as suspicious, the system reduces the cognitive load on frontline security personnel, potentially decreasing fatigue and improving overall threat response times. This targeted approach give the most critical alerts immediate, on-site attention from trained personnel who can quickly escalate or resolve potential security risks.

Simultaneously, the system may routes all "clear" indications from the X-ray scanner to a centralized data center staffed by a team of one or more trained analysts. Such data centers may be on-site or remote, depending on the nature of the system. The team can be dedicated to reviewing X-ray images that the AI system has deemed clear of threats, providing an additional layer of human oversight to catch any potential false negatives. By centralizing this review process, the system may leverage the expertise of specialized personnel who can maintain a higher level of focus and consistency in their analysis, free from the distractions present in the bustling checkpoint environment. This approach not only enhances the overall security posture by introducing a secondary review of all scanned items but also allows for continuous improvement of the AI system through feedback loops and ongoing training based on human expert insights. The centralized nature of this clear alert review also facilitates more efficient staffing models, as a single team can potentially oversee multiple checkpoints across different locations, ensuring a standardized and thorough approach to security screening. Where an AI system is not monitoring the X-ray images, it is often desirable to send all X-ray images to the team of trained analysts who can focus on such images without other distractions posed by a security checkpoint.

Labeled sensor data may comprise sensor data (e.g., three-dimensional digital maps, digital models, digital images, digital movies, scans, etc.) described herein and label (i.e., identifying) data (e.g., digital position points, pixels, etc.) indicative of or otherwise associated with predetermined portions of the security check environment 100, such as the prohibited object detector 110, the security table 117, and the barriers 120. Labeled sensor data may thus comprise sensor data (e.g., three-dimensional digital maps, digital models, digital images, digital movies, scans, etc.) described herein and label (i.e., identifying) data (e.g., digital position points, pixels, etc.) indicative of or otherwise associated with predetermined portions of the security check environment 100, such as the prohibited object detector 110, the security table 117, the barriers 120, the human security officers 112, the human patrons 114, and/or the objects 116 carried by the human patrons 114. Label data may thus associate the sensor data with corresponding (or real-world) predetermined portions of the security check environment 100.

Labeled sensor data may comprise, be indicative of, or otherwise be based on intended, proper, or otherwise optimal configurations (e.g., positions) of the security check environment 100, such as when the prohibited object detector 110 and the barriers 120 are positioned or arranged in an intended, proper, or be otherwise optimal manner such that the security check operations can be performed in an optimal manner. An AI model may thus comprise, be indicative of, or otherwise be based on intended, proper, or otherwise optimal configurations of the security check environment 100. For example, the AI model may be based on images or movies of the prohibited object detector 110 when the prohibited object detector 110 and the barriers 120 are positioned in an intended, proper, or otherwise optimal manner.

Labeled sensor data may be indicative of or otherwise based on intended, proper, or otherwise optimal configurations (e.g., positions, movements, etc.) of the security check environment 100, such as when the human patrons 114 move in an intended, proper, or otherwise optimal manner such that the human security officer 112 and/or the prohibited object detector 110 can perform the security check operations of the human patrons 114 in an optimal manner. An AI model may thus also be indicative of or otherwise based on intended, proper, or otherwise optimal positions and/or movements of the human patrons 114. An AI model may thus be indicative of or otherwise based on intended, proper, or otherwise optimal positions and/or movements of the human patrons 114. For example, the AI model may be based on images or movies of the human patrons 114 being positioned in and/or moving through the prohibited object detector 110 in an intended, proper, or otherwise optimal manner.

Labeled sensor data may be indicative of or otherwise based on intended, proper, or otherwise optimal configurations (e.g., positions, movements, etc.) of the security check environment 100, such as when the human security officers 112 are positioned (i.e., stationed) or move in an intended, proper, or otherwise optimal manner such that the human security officer 112 can perform the security check operations in an optimal manner. An AI model may thus be indicative of or otherwise based on intended, proper, or otherwise optimal positions and/or movements of the human security officers 112. For example, the AI model may be based on images or movies of: the human security officers 112 being positioned in intended, proper, or otherwise optimal locations with respect to other portions of the security check environment 100; and/or the human security officers 112 performing the security check operations (e.g., moving the handheld metal detector along a U-shaped path 236 along the body of the human patron 114) in intended, proper, or otherwise optimal manner.

After the AI model is generated, the processing device 300 may store the AI model on one or more of the memories 318, 320, 314, 330, 334 of the processing device 300. Thereafter, during security check operations, the processing device 300 may execute the AI model and analyze new sensor data indicative of physical characteristics of various portions of the security check environment 100 output by the sensors 202, 204 using the AI model. The AI model may analyze the new sensor data to find data patterns in the new sensor data that are similar to know (i.e., trained or taught) data patterns of the AI model indicative of known portions of the security check environment 100 in order to recognize (or associate) the predetermined portions (e.g., the prohibited object detector 110, the human security officers 112, the human patrons 114, the objects 116, etc.) of the security check environment 100 (i.e., to predict which data points are associated with which predetermined portion of the security check environment 100) defined by the new sensor data. The processing device 300 may then associate physical characteristics indicated by the new sensor data with corresponding (or recognized) predetermined portions of the security check environment 100.

The AI model may analyze the new sensor data associated with predetermined portions (e.g., the prohibited object detector 110, the human security officers 112, the human patrons 114, etc.) of the security check environment 100 to determine (i.e., measure) positions and/or movements of the predetermined portions of the security check environment 100 and compare them to the intended, proper, or otherwise optimal positions and/or movements of the predetermined portions of the security check environment 100. Thereafter, the processing device 300 may determine whether the security check operations are being performed in a suboptimal manner based on differences between the determined positions and/or movements of the predetermined portions of the security check environment 100 and the optimal positions and/or movements of the predetermined portions of the security check environment 100.

The present disclosure is further directed to example methods (e.g., operations, processes, actions) for operating or commencing operation of the monitoring system 200 and/or the security check environment 100, as described herein according to one or more aspects of the present disclosure. The example methods may be performed utilizing or otherwise in conjunction with at least a portion of one or more implementations of one or more instances of the apparatus shown in one or more of FIGS. 1-10, and/or otherwise within the scope of the present disclosure. For example, the methods may be performed and/or caused, at least partially, by a processing device, such as the processing device 300 executing program code instructions 332 according to one or more aspects of the present disclosure. Thus, the present disclosure is also directed to a non-transitory, computer-readable medium comprising the program code instructions 332 that, when executed by the processing device 300, may cause the processing device 300, the monitoring system 200, and/or the security check environment 100 to perform the example methods described herein. The methods may also or instead be performed and/or caused, at least partially, by human personnel (e.g., the human security officers 112) utilizing one or more instances of the apparatus shown in one or more of FIGS. 1-10, and/or otherwise within the scope of the present disclosure. However, the methods may also be performed in conjunction with implementations of apparatus other than those depicted in FIGS. 1-10 that are also within the scope of the present disclosure.

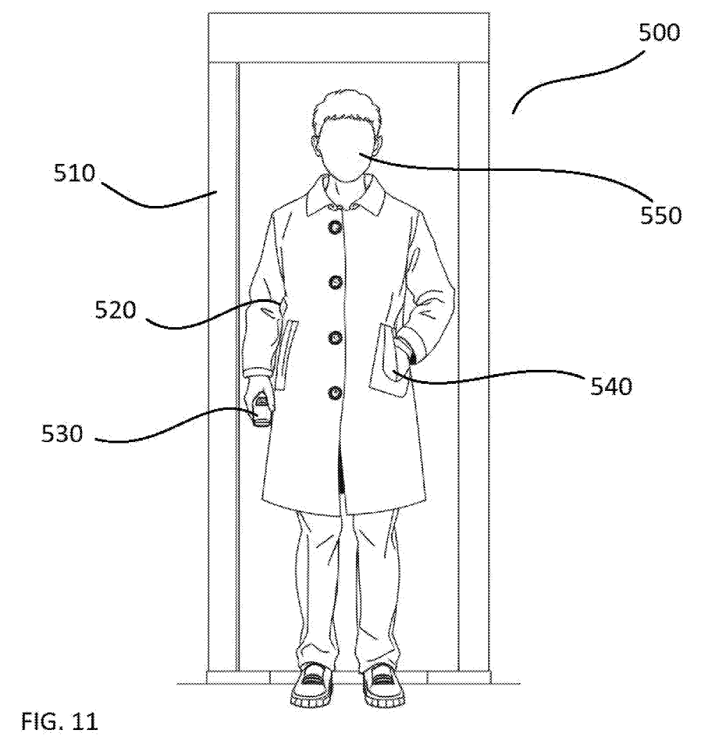

In FIG. 11, an illustration of a security checkpoint scenario is presented, showcasing potential evasion techniques that the inventive system is designed to detect. The figure depicts a security checkpoint environment 500, which represents a typical screening area found in various high-security locations such as airports, government buildings, or large public venues.

Central to the illustration is a person 550 in the process of walking through a detector 510. The detector 510 is representative of standard security screening equipment, such as a metal detector or millimeter wave scanner, commonly used to identify concealed objects or materials of concern.

The person 550 is shown exhibiting several suspicious characteristics that could indicate attempts to evade security measures. Bulging pocket 540: The individual's pocket is noticeably protruding, suggesting the presence of an object that may be intentionally concealed. This bulge could potentially hide prohibited items such as weapons, contraband, or other security threats. Unknown item 520 in the armpit: An unidentified object is positioned in the person's armpit area. This location is significant as it's a common technique used to exploit limitations in some scanning technologies. Certain types of detectors, particularly those relying on millimeter wave technology, may have difficulty penetrating this area of the body effectively. Water bottle 530 in a hand: The person is carrying a water bottle, which might seem innocuous at first glance. However, in the context of security screening, a water bottle can be used as a potential shielding device. Some individuals attempting to bypass security may use water or other liquids to mask the presence of prohibited items, as certain scanning technologies can be affected by the presence of fluids.

This illustrates the complexity of security screening and various methods that individuals might employ to evade detection. The security checkpoint system described in this invention is specifically designed to identify and flag these types of suspicious behaviors and potential evasion attempts. By utilizing advanced sensors, wireframe modeling, and artificial intelligence analysis, the system can detect subtle indicators that might be missed by traditional screening methods or human observers.

The combination of the bulging pocket, concealed armpit item, and strategically held water bottle represents a multi-faceted evasion attempt that underscores the need for sophisticated, AI-driven security screening systems capable of analyzing complex scenarios and identifying potential threats in real-time. Yet any one of the behaviors alone might demand further screening.

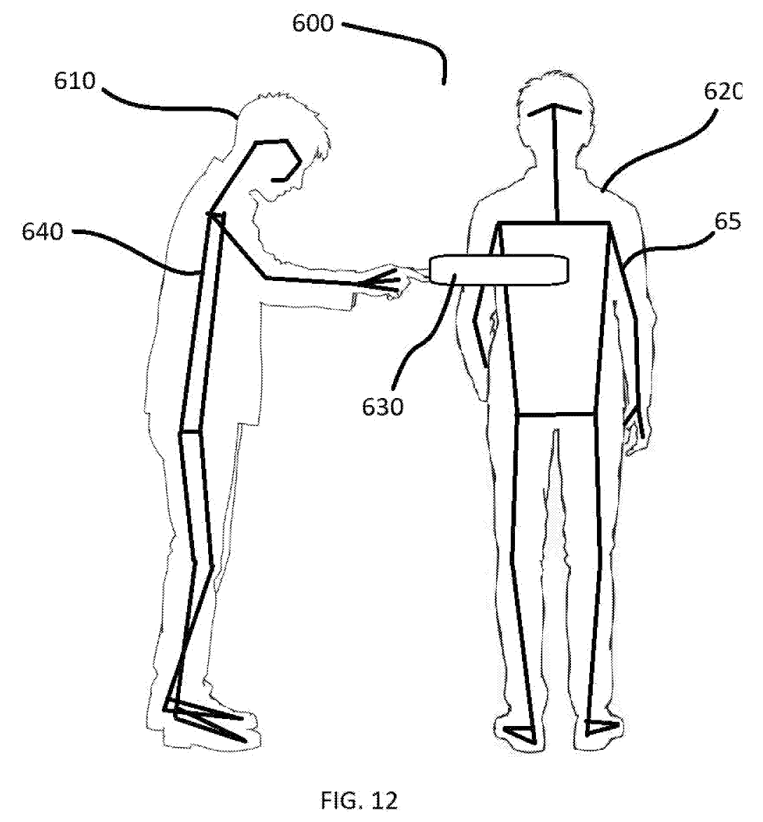

In FIG. 12, a security screening scenario is illustrated, showcasing the advanced capabilities of the AI-driven security checkpoint system. The scene depicts a security officer 610 conducting a manual screening of a person 620 using a metal detector wand 630. This interaction represents a common secondary screening procedure employed when initial automated screening methods have flagged a potential concern or for random security checks.

The inventive AI system has been specifically trained to generate accurate wireframe models of human bodies in real-time. In this illustration, the system has created two distinct wireframes: wireframe 640 representing the security officer 610, and wireframe 650 representing the person 620 being screened.

These wireframes are sophisticated skeletal representations that capture the key points and articulations of the human body, including joints, limbs, and overall posture. The AI system uses advanced computer vision algorithms, preferably incorporating deep learning models such as convolutional neural networks, to analyze video feeds from multiple angles and generate these 3D wireframe models.

The wireframe 640 of the security officer 610 allows the AI system to assess the officer's screening techniques and adherence to proper protocols. The system has been trained on a database of correct screening procedures, enabling it to recognize and evaluate the officer's movements in real-time. It can detect, for instance: The proper positioning of the officer relative to the person being screened; The correct handling and movement of the metal detector wand 630; The thoroughness of the scanning process, ensuring all required body areas are covered; and/or The appropriate distance maintained between the officer and the person being screened.

Similarly, the wireframe 650 of the person 620 being screened allows the AI to analyze their posture, movements, and potential attempts to conceal items or evade thorough screening. The system can detect suspicious behaviors such as: Unusual body positioning that might indicate concealment; Attempts to move away from or interfere with the wand's operation; and/or Subtle gestures or movements that might suggest nervousness or deception.

By simultaneously analyzing both wireframes, the AI system can evaluate the entire screening interaction. It can ensure that the officer is following proper procedures while also monitoring the person being screened for any suspicious behavior. This dual analysis significantly enhances the effectiveness and consistency of the screening process.

The AI system's ability to generate and analyze these wireframes in real-time represents a significant advancement in security screening technology. It provides a level of consistent, unbiased observation that surpasses human capabilities, especially in busy checkpoint environments where fatigue or distraction might affect human observers.

Certain embodiments of the security checkpoint system may incorporate advanced monitoring capabilities to ensure the safe operation of X-ray scanning equipment. One potentially important aspect of this monitoring is the continuous tracking of the X-ray machine operator's presence and position relative to the equipment. Such monitoring may be achieved through one or more of proximity sensors, AI-powered analysis of wireframe models representing the X-ray machine operator, and other specialized sensors deployed around the X-ray station. The system may be programmed to detect when an operator steps away from the X-ray machine, initiating a safety countdown timer. If the operator does not return within a predetermined time frame, typically a matter of seconds, the system may automatically initiate a shutdown sequence for the X-ray equipment. This automated safety feature is designed to prevent potential harm to visitors or unauthorized personnel who might approach or interact with the unattended X-ray machine, as the active X-ray emission poses a significant health risk if improperly managed.

The monitoring system's flexibility allows for various implementation methods to suit different security checkpoint layouts and operational requirements. Proximity sensors can be strategically placed around the X-ray station to create a defined "operator zone," triggering the countdown timer when the operator leaves this area. Alternatively, the AI-driven wireframe analysis can track the operator's movements with high precision, distinguishing between normal operational movements and a complete departure from the workstation. Additional sensors, such as pressure-sensitive floor mats or optical barriers, can provide redundant detection capabilities to ensure foolproof monitoring. This multi-layered approach not only enhances safety but also allows for detailed logging of operator behavior, which can be used for performance evaluations, training improvements, and optimization of checkpoint procedures. The system's rapid response and automatic shutdown feature demonstrate a proactive approach to visitor safety, acknowledging that even standard security equipment can pose risks if not properly supervised.

Moreover, this system can be continuously updated and improved. As new screening procedures are developed or new evasion techniques are discovered, the AI can be retrained to recognize and respond to these changes, ensuring that the security checkpoint remains effective against evolving threats.

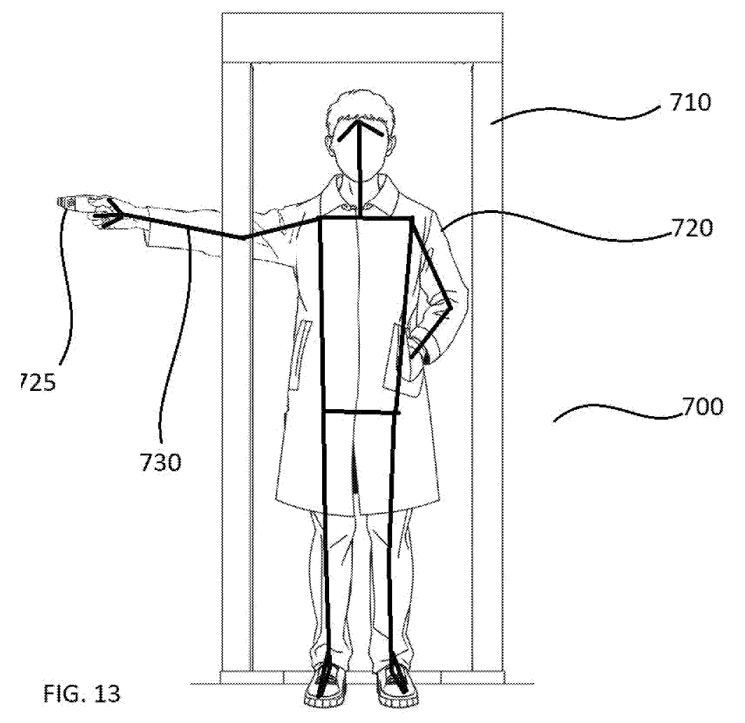

In FIG. 13, an illustration is presented of a potential security evasion scenario, demonstrating the sophisticated detection capabilities of the AI-powered security checkpoint system. The scene depicts a person 720 moving through a metal detector 710 in a manner that raises suspicion of an evasion attempt 700.

The metal detector 710 represents a standard security screening device commonly found in various high-security environments. It is designed to detect metallic objects as individuals pass through its detection field. However, this scenario highlights a common limitation of such devices, i.e., their inability to detect objects outside their immediate scanning area.

The person 720 is shown in a position that suggests a deliberate attempt to circumvent the metal detector's capabilities. Specifically, the individual has extended their arm outside the confines of the metal detector 710. In this extended hand, the person is holding an unknown item 725. This positioning is significant because objects held outside the metal detector's scanning field may not trigger an alert, even if they would normally be detected.

The inventive AI system has generated a wireframe 730 to approximate the position of the person 720's body. This wireframe is an important element in the system's analysis process. It represents a detailed skeletal model of the person, capturing key points such as joints, limbs, and overall body posture.

The wireframe 730 is generated in real-time using advanced computer vision algorithms and machine learning models. These models have been trained on datasets of human movements, including both normal behaviors and known evasion techniques. This training allows the AI to quickly and accurately map the person's body position and movements.

In this specific instance, the AI system is using the wireframe 730 to analyze several key factors: the overall body posture of the person 720, which deviates from the expected upright, arms-at-sides position typically seen during metal detector screenings; the extended arm position, which is flagged as unusual and potentially suspicious; the presence of the unknown item 725 in the person's hand, combined with its position outside the metal detector's scanning field; and/or the trajectory and speed of the person's movement through the checkpoint, which may indicate an attempt to pass through quickly to avoid detection.

The AI system correlates these observations with its trained knowledge of evasion techniques. In this case, the placement of the hand and unknown item 725 outside of the metal detector 710 strongly indicates an evasion attempt. This behavior matches known patterns of individuals trying to smuggle prohibited items through security checkpoints.

Upon detecting this suspicious behavior, the AI system would typically trigger an alert. This alert could be sent to security personnel in real-time, allowing for immediate intervention. The system might also flag this individual for additional screening or questioning.

This scenario demonstrates the AI system's ability to detect subtle evasion attempts that might be missed by traditional security measures or even human observers. By continuously monitoring and analyzing body positions and movements, the system provides an additional layer of security that is constantly vigilant and unaffected by factors like fatigue or distraction that can impact human security personnel.

Furthermore, encounters like this one can be used to further train and refine the AI system. By incorporating new evasion techniques into its training data, the system can continuously improve its detection capabilities, staying ahead of evolving security threats.

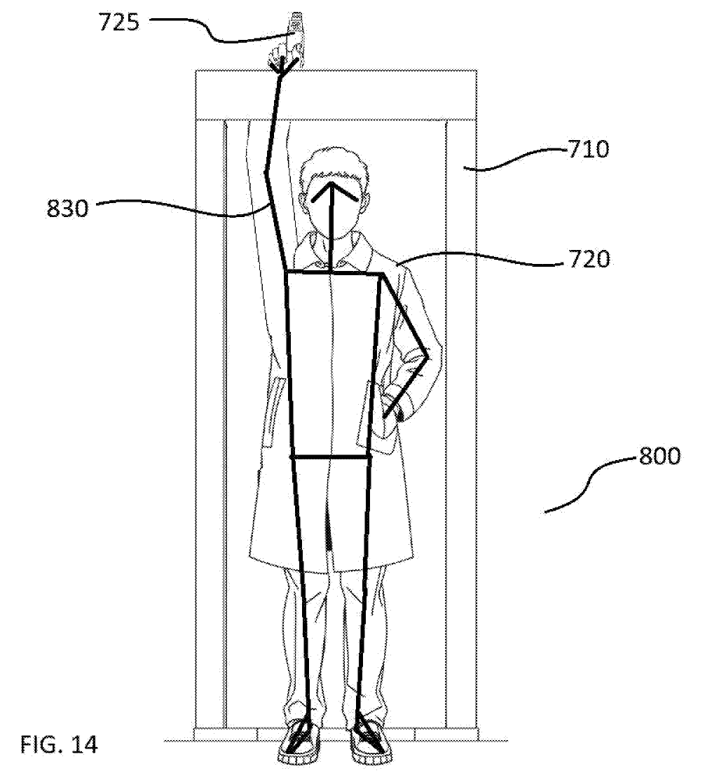

In FIG. 14, we observe another illustration of a potential security evasion scenario, further demonstrating the advanced detection capabilities of the AI-powered security checkpoint system. This scene portrays a person 720 moving through a metal detector 710 in a manner that strongly suggests an evasion attempt 800, but with a different approach compared to the previous figure.

The metal detector 710, as in the previous scenario, represents standard security screening equipment commonly used in high-security environments. It is designed to detect metallic objects within its scanning field, which typically covers the body of a person passing through it. However, this scenario highlights another critical limitation of many such devices - their limited vertical detection range.

In this instance, the person 720 is depicted in a posture that raises immediate suspicion. The individual has extended their arm upwards, positioning their hand and an unknown item 725 above the top of the metal detector 710. This positioning is a clear attempt to exploit the vertical limitations of the detector's scanning field.

The AI system, leveraging its advanced capabilities, has generated a wireframe 830 to model the position and posture of the person 720. This wireframe is a crucial component of the system's analysis process, representing a detailed skeletal model of the person that captures key points such as joints, limbs, and overall body posture.

The wireframe 830 is created in real-time using sophisticated computer vision algorithms and machine learning models. These models have been extensively trained on diverse datasets of human movements, encompassing both normal behaviors and known evasion techniques. This comprehensive training enables the AI to swiftly and accurately map the person's body position and movements, even in unusual poses like the one displayed here.

In analyzing this specific scenario, the AI system utilizes the wireframe 830 to evaluate several factors: the overall body posture of the person 720, which significantly deviates from the expected upright, arms-at-sides position typically observed during metal detector screenings; the unnaturally extended arm position above the detector, which is immediately flagged as highly unusual and suspicious; the presence of the unknown item 725 in the person's raised hand, positioned deliberately outside the metal detector's scanning field; and/or the trajectory and speed of the person's movement through the checkpoint, which may indicate an attempt to pass through quickly while maintaining the unusual posture.

The AI system correlates these observations with its extensive knowledge base of evasion techniques. In this case, the placement of the hand and unknown item 725 above the metal detector 710 is a clear indicator of an evasion attempt. This behavior aligns with known strategies employed by individuals attempting to smuggle prohibited items through security checkpoints by exploiting the vertical limitations of scanning equipment.

Upon detecting this highly suspicious behavior, the AI system would immediately trigger a high-priority alert. This alert would be instantaneously communicated to security personnel, enabling them to intervene promptly. The system would likely flag this individual for comprehensive additional screening, potentially including a full-body pat-down and thorough questioning.

This scenario exemplifies the AI system's capability to detect and respond to more overt evasion attempts. While such obvious attempts might be caught by attentive human observers, the AI system ensures that these evasions are never missed, even in high-traffic scenarios where human attention might waver. The system's constant vigilance provides an unwavering layer of security, immune to factors like fatigue, distraction, or lapses in concentration that can affect human security personnel.

Moreover, incidents like this contribute valuable data for further refining the AI system. By incorporating these more blatant evasion techniques into its training data, the system continuously enhances its detection capabilities. This adaptive learning approach ensures that the security checkpoint remains effective against a wide spectrum of evasion attempts, from subtle to overt, and can quickly adapt to new and emerging threat tactics.

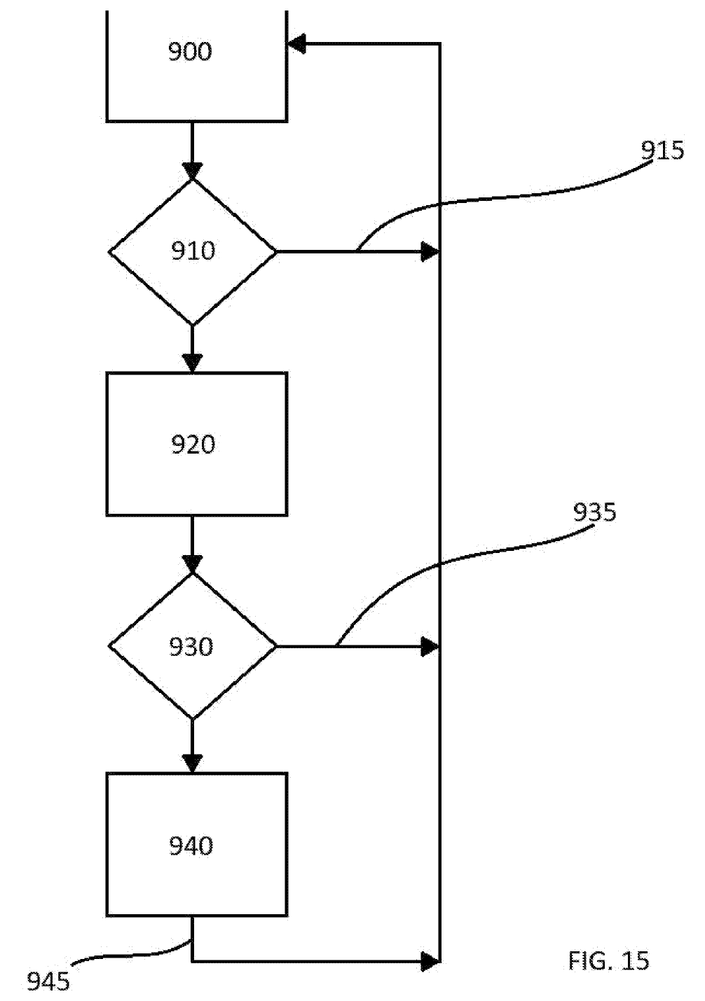

FIG. 15 presents a flowchart illustrating an audio analysis process that may be implemented within the AI-driven security checkpoint system. This process is designed to enhance the overall security by incorporating auditory data alongside visual and spatial information. The flowchart outlines a continuous cycle of listening, analysis, and alert generation, showcasing the system's ability to detect potential security threats through sound.

The process begins with the listening step 900, which represents the system's constant state of auditory vigilance. In this stage, advanced sound sensors, preferably comprising high-quality microphones strategically placed in various locations or throughout the security checkpoint area, are actively monitoring the environment. These sensors are preferably calibrated to pick up a wide range of frequencies and sound levels, ensuring that even subtle audio cues are not missed.

When a sound is detected that meets certain predefined criteria (referred to as an audio trigger), the process moves to the audio trigger analysis step 910. Notably, it is preferable to continue monitoring through listening step 900 while audio triggers are processed; thus, it is possible to instantiate step 910 as a separate process without terminating step 900. And numerous analysis steps 910 may be simultaneously or sequentially processed while listening step 900 continues monitoring without interruption. Step 910 involves a preliminary assessment of the detected sound to determine if it warrants further investigation. The audio trigger could be based on various factors such as sudden volume increases, specific frequency patterns, or matches to pre-programmed sound signatures associated with potential security threats.

If no audio trigger is detected during the listening phase, the process simply returns 915 to the listening state 900, maintaining its vigilant monitoring. This loop ensures continuous surveillance without unnecessary processing of ambient noise or irrelevant sounds. Or if step 910 is instantiated as a separate process while step 900 continues monitoring, then it is possible to simply terminate the newly instantiated step 910 and permit step 900 to continue monitoring.

However, if an audio trigger is detected, the process advances to the more intensive audio analysis state 920. In this stage, the AI system employs audio processing algorithms to conduct a more detailed examination of the sound. This analysis might include: 1. Speech recognition to identify specific words or phrases that could indicate a threat; 2. Emotion detection in voices to identify signs of aggression, fear, or distress; 3. Sound classification to identify specific noises like breaking glass, gunshots, or explosions; and/or 4. Background noise analysis to detect unusual patterns or sudden changes in the ambient sound environment.

The AI system then uses the results of this analysis to make an alert determination 930. This step preferably involves decision-making algorithms that weigh various factors such as the nature of the sound, its context within the overall security environment, and/or its correlation with other sensor data (e.g., visual cues from cameras).

If the alert determination 930 concludes that an alert is not necessary, the process returns 935 to the listening state 900. Or if step 910 was instantiated as a separate process while step 900 continued monitoring, then it is possible to simply terminate the newly instantiated process at step 930 and permit step 900 to continue monitoring. This might occur if the system determines that the analyzed sound was a false positive or a non-threatening event.

However, if the system determines that an alert is appropriate, it proceeds to create and report an alert 940. This alert generation process may involve multiple analyses. It may be preferable to categorize the severity and nature of the potential threat. It may further be preferable to compile relevant data from the audio analysis and potentially corroborating information from other sensors. It may be preferable to format an alert for quick comprehension by security personnel, depending on the type of alert to be generated. And it is preferable to transmit the alert through predetermined channels (e.g., to a central security monitoring station, to on-site security personnel's devices, or to a broader security network).

After the alert is generated and reported, the system returns 945 to the listening state 900, ensuring that audio monitoring continues uninterrupted. Or if step 910 was instantiated as a separate process while step 900 continued monitoring, then it is possible to simply terminate the newly instantiated process at step 940 and permit step 900 to continue monitoring.

This process demonstrates the system's ability to provide constant, real-time audio surveillance, quickly identify and analyze potential threats, and generate timely alerts when necessary. The integration of this audio analysis with the system's visual and spatial monitoring capabilities permits a multi-modal approach to security threat detection.

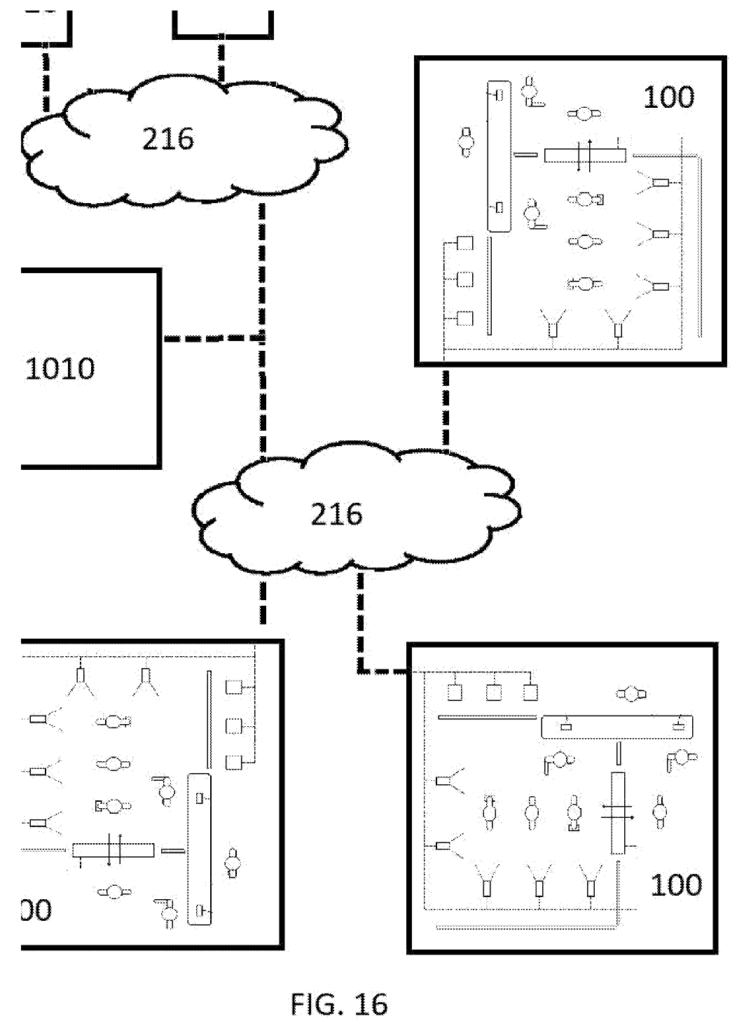

FIG. 16 illustrates an embodiment of a networked security system that integrates multiple security checkpoints with centralized monitoring and control capabilities. This system demonstrates the scalability and versatility of the AI-driven security checkpoint system disclosed herein.

Multiple security checkpoints 100 represent individual screening areas equipped with the AI-powered detection systems described in previous figures. These checkpoints could be deployed in various configurations:
1. Multiple checkpoints within a single large facility (e.g., different entrances to an airport terminal);
2. Checkpoints spread across different facilities within the same organization (e.g., multiple buildings in a government complex);
3. Checkpoints in completely separate locations (e.g., different airports or border crossings); and/or
4. Checkpoints in locations related to different organizations.

Security checkpoints 100 are preferably interconnected via one or more networks 216. These networks may employ secure, high-bandwidth connections to ensure real-time data transmission and minimal latency. Networks 216 may utilize a combination of local area networks (LANs), wide area networks (WANs), virtual private networks (VPNs), and/or potentially satellite links for remote locations, and may be interconnected by wired, wireless, optical, and/or other connections, as denoted by the dashed lines in FIG. 16.

The network preferably connects the checkpoints to one or more security operations centers 1010. Centers 1010 preferably serve as the hub for monitoring and managing the entire security system. They are preferably staffed by trained security personnel who can monitor real-time feeds from multiple checkpoints simultaneously, receive and respond to alerts generated by the AI systems, coordinate responses to potential security threats, analyze trends and patterns across multiple checkpoints, and/or update and refine the AI models based on new data and emerging threats.

The distributed security system 1000 may also include one or more remote operations centers 1020. These centers may provide redundancy and additional support, allowing for 24/7 monitoring capabilities through different time zone, specialized expertise that can be leveraged across multiple locations, backup operations in case of issues at the primary security operations center, and distributed processing of large-scale data analysis tasks. Analysis tasks may be performed through an edge network, through a centralized data center, through cloud computing, or in other manners.

The network 216 is also preferably connected to one or more auxiliary notification functions 1030. Function 1030 represents a range of alert and communication systems that can be triggered based on the security situation. These may include, for example, mobile app notifications sent to security personnel's smartphones, tablets, or other electronic devices, SMS or other format text (or multi-media) alerts for rapid dissemination of critical information, pager notifications, automated phone calls to key personnel or emergency services, email notifications for less time-sensitive updates (e.g., reporting on minor or inconsequential deviations from procedure that can be addressed with security officers at a later time), integration with public address systems for facility-wide announcements, triggering of local alarms or lockdown procedures, and/or updates to digital signage or information displays within the facility.

The auxiliary notification functions can be standardize and/or customized based on the severity and nature of the detected threat, ensuring that the correct people or systems receive the correct information through the most appropriate channels.

This networked architecture provides vaious advantages including centralized monitoring and control, allowing for efficient use of security personnel, rapid sharing of threat information across multiple checkpoints and facilities, the ability to quickly update AI models and security protocols across the entire system, scalability to add new checkpoints or integrate with other security systems, and/or redundancy and resilience in case of local system failures or security breaches.

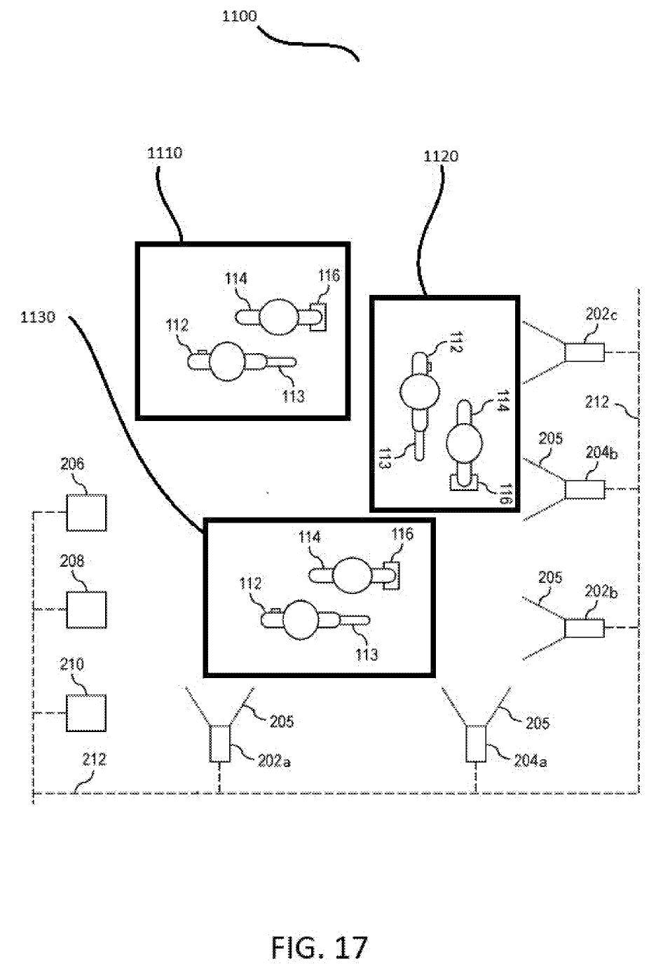

FIG. 17 presents an overhead view of an illustration of various screening positions within a security checkpoint, highlighting the critical importance of proper positioning and orientation for enhancing AI system monitoring functionality. This demonstrates how the effectiveness of the AI-powered security system can be impacted by the relative positions of the security officer, the patron being screened, and the various monitoring devices.

The figure depicts three distinct screening positions among the infinite number of potential screening positions. It is often preferably to place markers on the floor to indicate preferred positioning of officer 112 and patron 114.

In screening position 1110, the security officer 112 and the patron 114 are positioned in a way that maximizes visibility for multiple monitoring devices. The interaction between the security wand 113 and the patron 114 is visible to all five depicted monitoring devices: 202a, 202b, 202c, 204a, and 204b. (Notably more or fewer monitoring devices may be present, which may affect the usefulness of the various screening positions.) Position 1110 allows the AI system to gather data from multiple angles, enhancing accuracy of the analysis of the screening process. The clear line of sight to all depicted devices enables the system to: 1. Accurately track the movement of the security wand; 2. Monitor the officer's adherence to proper screening protocols; 3. Detect any suspicious movements or reactions from the patron; and/or 4. Provide a view of the screening interaction from multiple angles.

Position 1120 illustrates a suboptimal screening arrangement. Here, the patron 114 is positioned in a way that likely obstructs the view of one or more monitoring devices (202b, 202c, 204a, and 204b) from observing the interaction between the officer 112 and the wand 113. This obstruction can significantly impair the AI system's ability to fully assess the thoroughness of the screening process, detect potential concealment attempts by the patron, evaluate the officer's adherence to proper wanding techniques, and/or gather comprehensive data for ongoing system improvement. The limited visibility in this scenario could lead to potential security risks going undetected, undermining the effectiveness of AI augmentation of the checkpoint.

Position 1130 represents a screening position that is likely worse than position 1110 and better than 1120. In position 1130, the patron 114 partially or fully blocks the view of the wand 113 and security officer 112 from devices 202c and 204b, but clear visibility is likely maintained for devices 202b, 202a, and 204a. While not ideal, this position may allow the AI system to monitor the majority of the screening interaction. During this monitoring, the AI system might still maintain a good view of the wand's movement across the patron's body, detect most potential evasion attempts or suspicious behaviors, and/or assess the officer's screening technique from multiple angles. However, the partial obstruction may still result in some blind spots that could potentially be exploited.

The varying effectiveness of these positions underscores the benefit that the AI system might provide for use with evaluating security personnel. Officers may be given direction as to preferred positioning techniques that enhance visibility for all monitoring devices. This could involve: 1. Developing standardized screening positions and orientations; 2. Implementing visual guides or markers on the floor to indicate ideal standing positions; 3. Providing real-time or delayed feedback to officers on their positioning through the AI system; and/or 4. Regular training and assessment of officers' positioning techniques

Furthermore, this illustration highlights reasons for strategic placement of monitoring devices within the checkpoint area. The security system should preferably be designed with an aim to minimize potential blind spots and seek comprehensive coverage from multiple angles.

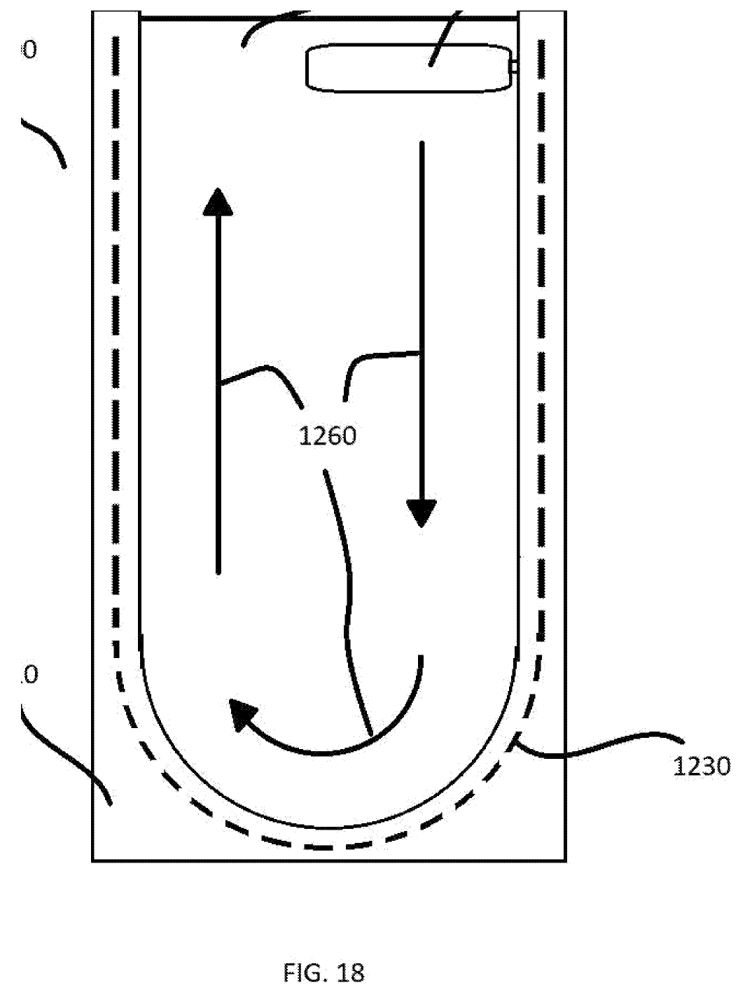

FIG. 18 illustrates an innovative automated scanning robot 1200, designed to enhance security screening processes by combining the precision of robotics with advanced detection technology, while removing the human element that may cause errors or discomfort during screening. This automated system aims to provide consistent, thorough, and contactless screening of patrons, addressing some of the limitations and variabilities inherent in manual screening procedures.

The automated scanning robot 1200 preferably comprises several key components. Frame 1210 forms the primary structural support of the robot. It is likely constructed from durable materials such as steel or high-strength aluminum to ensure stability and longevity in a high-traffic security environment. The frame is preferably designed to house all the robot's components while maintaining a compact footprint suitable for security checkpoints. Conveyor 1230 may be housed within or upon the frame 1210 and is represented by dashed lines in the figure, indicating its preferred internal placement. The conveyor system is responsible for moving the scanning wand 1240 in a precise, controlled manner. It preferably utilizes a combination of motors, belts, tracks, pulleys, and/or other mechanical conveyance mechanisms to achieve smooth and accurate movement that approximates the movement of a human wand operator but in a more precise manner. Wand 1240 is the primary scanning device of this embodiment, similar to handheld metal detectors used in manual screenings. However, in this automated system, the wand is attached to the conveyor mechanism. The wand preferably incorporates advanced sensor technology, potentially including metal detection, millimeter wave scanning, or other security screening capabilities. More than one wand or sensor device may be incorporated in a scanning robot 1200. Transparent Screen 1250 may be employed as a safety and hygiene feature of the system. The transparent screen, preferably made of shatter-resistant material such as polycarbonate, plexiglass, safety glass, or other transparent materials, serves as a barrier between the moving wand 1240 and the patron being scanned. This design element preferably prevents direct contact between the wand and the patron, eliminating concerns about physical touch during screening. Transparency may make the scanning process visible to the patron, promoting trust in the screening procedure. Screen 1250 may also protect the wand and any sensors from potential damage, interference, or evasive manuevers by patrons. Alternatively, it is possible to use a screen 1250 that is not transparent to human vision, provided that the screen is preferably transparent to the sensors of wand 1240.

FIG. 18 depicts a "U"-shaped path of travel for the wand 1240. This movement pattern is designed to provide comprehensive coverage of the patron's body during scanning in accord with preferred scanning practices. The U-shape allows the wand to move down one side of the body, across the lower body, and up the other side of the body. This pattern is a means of attempting to ensure that the entire body is scanned thoroughly and consistently, potentially reducing the likelihood of missed detections that can occur with manual scanning. The pattern of the wand and/or configuration of robot 1200 may be altered if preferred scanning practices are changed.

The automated nature of this system offers several advantages. Every scan follows the exact same pattern, eliminating variations that can occur with human-operated wands. The robotic system can potentially perform scans more quickly than a human operator. The system can operate continuously without the fatigue that affects human screeners during long shifts. The automated system can precisely record each scan, potentially integrating with AI systems for advanced threat detection and pattern recognition. The transparent screen design also addresses privacy concerns often associated with pat-downs or close-proximity manual scanning, while still allowing for thorough security checks.

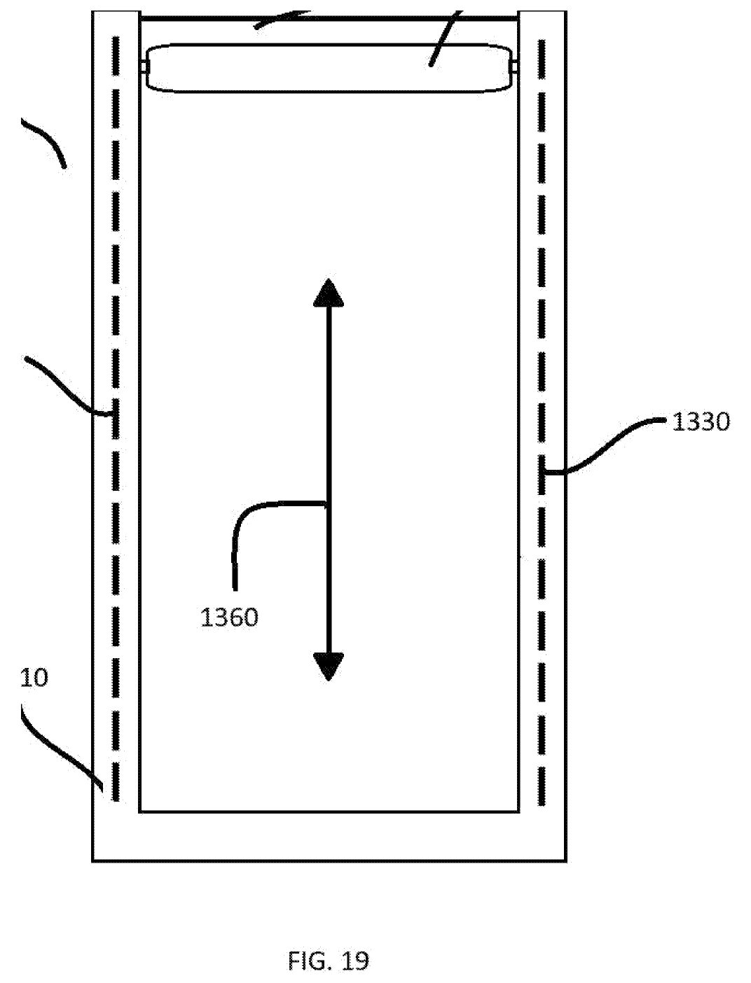

FIG. 19 illustrates another embodiment of an automated scanning robot 1300, building upon the concept introduced in FIG. 18 but with differences in its scanning mechanism and motion. This variation aims to provide an alternative approach to automated security screening, potentially offering advantages in certain checkpoint configurations or for specific screening requirements.

The automated scanning robot 1300 preferably comprises the following components. Frame 1310 preferably forms the structural foundation of the robot. It's likely constructed from robust materials such as steel or reinforced aluminum to ensure stability and durability in high-traffic security environments. The frame is designed to house the internal components while maintaining a slim profile, potentially allowing for easier integration into existing checkpoint layouts. Conveyor 1330 is preferably housed within or upon the frame 1310 and is represented by two dashed lines in the figure, indicating the preferred internal placement. This conveyor system is designed to move the wand in a vertical, straight-line path. It likely employs a combination of precision motors, linear actuators, guide rails, and/or other mechanical conveyance mechanisms to achieve smooth and accurate vertical movement. Extended Wand 1340 is the primary scanning device, but it differs from the previous design in that it is preferably designed to span a greater portion of the patron's body. The extended design could allow for more efficient scanning, possibly reducing the total movement required to cover the entire body. A single vertical scan could be employed (moving either up or down) for each patron. The wand preferably incorporates advanced multi-sensor technology, potentially combining metal detection with other screening sensors. Transparent Screen 1350 may be employed to serve multiple important functions. Screen 1350 may prevent direct contact between the wand 1340 and patrons, addressing hygiene concerns and maintaining a non-invasive screening process. It preferably allows patrons to observe the scanning process, promoting transparency and trust. It preferably protects the sensitive scanning equipment from potential damage or interference.

A straight, vertical path of travel 1360 is depicted for the extended wand 1340. This up-and/or-down movement pattern represents a departure from the U-shaped path of other embodiments. The vertical scanning motion offers several potential advantages. It may allow for faster scans, as the wand only needs to move in one dimension and possibly in one direction. This design can be used to simplify the mechanical conveyance mechanisms. The extended wand design coupled with vertical movement might provide more consistent coverage of the entire body.

The straight-line vertical scanning approach of this design offers several unique benefits. The linear motion mechanism may be mechanically simpler, potentially increasing reliability and reducing maintenance needs. The extended wand design could potentially provide more comprehensive coverage in a single pass.

In view of the entirety of the present disclosure, a person having ordinary skill in the art will readily recognize that the present disclosure provides at least systems comprising: a sensor operable to output sensor data indicative of physical characteristics of a security check environment; an output device; and a processing device comprising a processor and a memory storing a computer program code which when executed by the processor causes the processing device to: determine, based on the sensor data, that security check operations at the security check environment are being performed in a suboptimal manner; and in response to determining that the security check operations are being performed in a suboptimal manner, output alarm data to the output device to cause the output device to output an alarm signal indicative of the suboptimal manner in which the security check operations are being performed.

The security check environment may comprise at least one of: a prohibited object detector operable to detect a potentially prohibited object; a human patron who intends to walk through the prohibited object detector; an object carried by the human patron; and a human security officer. The prohibited object detector may comprise at least one of: a metal detector; an X-ray machine; a millimeter wave scanner; a trace portal machine; a frequency machine; a radio wave signal machine; and a weapons detection system. The sensor may comprise a ranging device. The sensor may also or instead comprise a digital video camera.

The sensor may be a first sensor, the sensor data may be a first sensor data, and the first sensor may comprise a digital video camera. The system may further comprise a second sensor comprising a ranging device operable to output second sensor data indicative of the physical characteristics of the security check environment, and determining that the security check operations are being performed in a suboptimal manner may be further based on the second sensor data.

The sensor may be a first sensor, the sensor data may be a first sensor data, and the first sensor may comprise a digital video camera. The system may further comprise a second sensor comprising a ranging device operable to output second sensor data indicative of the physical characteristics of the security check environment, the computer program code executed by the processor may further cause the processing device to generate a three-dimensional digital map of the security check environment based on the first and second sensor data, and determining that the security check operations are being performed in a suboptimal manner may be further based on the three-dimensional digital map.

The computer program code executed by the processor further may cause the processing device to: generate a first digital model of the prohibited object detector based on the sensor data; generate a second digital model of the human patron based on the sensor data; and determine a position of the human patron with respect to the prohibited object detector based on the first and second digital models. Determining that the security check operations are being performed in a suboptimal manner may be based on the determined position of the human patron with respect to the prohibited object detector.

The suboptimal performance of the security check operations may comprise at least one of: the human patron walking around and not through the prohibited object detector; the human patron carrying an object through the prohibited object detector; the human patron walking through the prohibited object detector while positioning at least one hand outside of the prohibited object detector; the human patron walking through the prohibited object detector while carrying an object outside of the prohibited object detector; the human patron walking through the prohibited object detector while positioning at least one hand outside of a prohibited object detection area of the prohibited object detector; the human patron walking through the prohibited object detector while carrying an object outside of the prohibited object detection area; the human patron failing to walk back through the prohibited object detector after the human patron walked through the prohibited object detector and the prohibited object detector detected a potentially prohibited object; the human patron failing to present to the human security officer a potentially prohibited object detected by the prohibited object detector; the human security officer failing to check the human patron for a potentially prohibited object detected by the prohibited object detector; the human security officer failing to maintain a predetermined post for a predetermined period of time; the human security officer failing to check the human patron using a predetermined check procedure; the human security officer failing to test operation of the prohibited object detector at a predetermined time; and the human security officer failing to test operation of the prohibited object detector using a predetermined test procedure.

The computer program code executed by the processor may further cause the processing device to: determine an actual position of the prohibited object detector based on the sensor data; and determine a position difference between the actual position of the prohibited object detector and an intended position of the prohibited object detector. The suboptimal manner of performance of the security check operations may comprise operating the prohibited object detector to detect the potentially prohibited object when the position difference is greater than a predetermined threshold.

The computer program code executed by the processor may further cause the processing device to determine a distance between portions of the prohibited object detector based on the sensor data. The suboptimal manner of performance of the security check operations may comprise operating the prohibited object detector to detect the potentially prohibited object when the distance is: greater than a maximum predetermined distance between the portions of the prohibited object detector; or less than a minimum predetermined distance between the portions of the prohibited object detector.

The present disclosure also introduces a system comprising: a digital video camera operable to output first sensor data; a ranging device operable to output second sensor data; an output device; and a processing device comprising a processor and a memory storing a computer program code which when executed by the processor causes the processing device to: generate a three-dimensional digital map of a security check environment based on the first and second sensor data; determine that the security check operations are being performed in a suboptimal manner based on the three-dimensional digital map; and in response to determining that the security check operations are being performed in a suboptimal manner, output alarm data to the output device to cause the output device to output an alarm signal indicative of the suboptimal manner in which the security check operations are being performed.

The security check environment may comprise at least one of: a prohibited object detector operable to detect a potentially prohibited object; a human patron who intends to walk through the prohibited object detector; an object carried by the human patron; and a human security officer. The prohibited object detector may comprise at least one of: a metal detector; an X-ray machine; a millimeter wave scanner; a trace portal machine; a frequency machine; a radio wave signal machine; and a weapons detection system.

The computer program code executed by the processor may further cause the processing device to: recognize the prohibited object detector in the three-dimensional digital map; recognize the human patron in the three-dimensional digital map; and determine a position of the human patron with respect to the prohibited object detector based on the three-dimensional digital map. Determining that the security check operations are being performed in a suboptimal manner may be further based on the determined position of the human patron with respect to the prohibited object detector.

The suboptimal manner of performance of the security check operations may comprise at least one of: the human patron walking around and not through the prohibited object detector; the human patron carrying an object through the prohibited object detector; the human patron walking through the prohibited object detector while positioning at least one hand outside of the prohibited object detector; the human patron walking through the prohibited object detector while carrying an object outside of the prohibited object detector; the human patron walking through the prohibited object detector while positioning at least one hand outside of a prohibited object detection area of the prohibited object detector; the human patron walking through the prohibited object detector while carrying an object outside of the prohibited object detection area; the human patron failing to walk back through the prohibited object detector after the human patron walked through the prohibited object detector and the prohibited object detector detected a potentially prohibited object; the human patron failing to present to the human security officer a potentially prohibited object detected by the prohibited object detector; the human security officer failing to check the human patron for a potentially prohibited object detected by the prohibited object detector; the human security officer failing to maintain a predetermined post for a predetermined period of time; the human security officer failing to check the human patron using a predetermined check procedure; the human security officer failing to test operation of the prohibited object detector at a predetermined time; and the human security officer failing to test operation of the prohibited object detector using a predetermined test procedure.

The computer program code executed by the processor may further cause the processing device to: determine an actual position of the prohibited object detector based on the three-dimensional digital map; and determine a position difference between the actual position of the prohibited object detector and an intended position of the prohibited object detector. The suboptimal manner of performance of the security check operations may comprise operating the prohibited object detector to detect the potentially prohibited object when the position difference is greater than a predetermined threshold.

The present disclosure also introduces a system comprising a sensor operable to output sensor data; an output device; and a processing device comprising a processor and a memory storing a computer program code which when executed by the processor causes the processing device to: determine an actual position of a prohibited object detector operable to detect a prohibited object based on the sensor data; determine a position difference between the actual position of the prohibited object detector and an intended position of the prohibited object detector; and, based on the position difference being greater than a predetermined threshold, output alarm data to the output device to cause the output device to output an alarm signal indicative of at least one of: the actual position of the prohibited object detector; the position difference; and existence of the position difference.

The sensor may comprise a ranging device. The sensor may also or instead comprise a digital video camera.

The sensor may be a first sensor, the sensor data may be a first sensor data, and the first sensor may comprise a digital video camera. The system may further comprise a second sensor comprising a ranging device operable to output second sensor data. The computer program code executed by the processor may further cause the processing device to determine the actual position of the prohibited object detector based further on the second sensor data.

The actual position of the prohibited object detector may comprise an actual distance between portions of the prohibited object detector, and the intended position of the prohibited object detector may comprise an intended distance between the portions of the prohibited object detector.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract is provided to permit the reader to quickly ascertain the nature of the technical disclosure. It is submitted with the understanding that it will not be used to interpret or limit the scope or meaning of the claims.

What is claimed is:

1. A security checkpoint system comprising:
a plurality of sensors configured to collect data points related to movements of one or more persons within a security checkpoint area;
a processing unit configured to:
receive the collected data points from the plurality of sensors; and
analyze movements of the one or more persons to detect potential attempts to evade security screening procedures; and
an alert mechanism configured to generate an alert when a potential evasion attempt is detected.

2. The security checkpoint system of claim 1, wherein
the analyzing movements of persons comprises:
generating a wireframe model of at least one person based on the collected data points; and
analyzing movements of the wireframe model.

3. The security checkpoint system of claim 1, wherein the processing unit is further configured to track movements of a plurality of persons simultaneously within the security checkpoint area.

4. The security checkpoint system of claim 1, wherein the processing unit is further configured to analyze movements of one or more security officers within the security checkpoint area to determine adherence by the one or more security officers to security screening protocols.

5. The security checkpoint system of claim 1, wherein the processing unit is configured to detect potential evasion attempts including at least one of: moving around a sensor, placing an object over a detection area of a sensor, moving an object quickly through a detection area of a sensor, and concealing an object in a body area that may interfere with detection by a sensor.

6. The security checkpoint system of claim 1, further comprising a security operations center configured to receive alerts generated by the alert mechanism.

7. The security checkpoint system of claim 1, wherein the processing unit is configured to analyze audio data collected within the security checkpoint area to detect potential security issues.

8. The security checkpoint system of claim 1, wherein the plurality of sensors includes at least two sensors configured to provide depth perception data.

9. The security checkpoint system of claim 1, wherein the processing unit is configured to compare analyzed movements to one or more predefined security screening procedures to identify deviations of the analyzed movements from the one or more predefined security screening procedures.

10. The security checkpoint system of claim 1, wherein the wireframe model includes data points representing a plurality of joints and a plurality of body parts of the one or more persons.

11. A method for enhancing security screening, the method comprising:
collecting, by a plurality of sensors, data points related to movements of one or more persons within a security checkpoint area;
generating, by a processing unit, a wireframe model of at least one person based on the collected data points;
analyzing, by the processing unit, movements of the wireframe model to detect potential evasion attempts by the at least one persons; and
generating an alert when a potential evasion attempt is detected.

12. The method of claim 11, further comprising tracking movements of a plurality of persons simultaneously within the security checkpoint area.

13. The method of claim 11, further comprising analyzing movements of one or more security officers within the security checkpoint area to determine adherence by the one or more security officers to security screening protocols.

14. The method of claim 11, wherein detecting potential evasion attempts includes identifying at least one of: moving around a sensor, placing an object over a detection area of a sensor, moving an object quickly through a detection area of a sensor, and concealing an object in a body area that may interfere with detection by a sensor.

15. The method of claim 11, further comprising analyzing audio data collected within the security checkpoint area to detect potential security issues.

16. The method of claim 11, further comprising comparing analyzed movements to one or more predefined security screening procedures to identify deviations of the analyzed movements from the one or more predefined security screening procedures.

17. The security checkpoint system of claim 2, wherein the processing unit is configured to use artificial intelligence to analyze the movements of the wireframe model for potential evasive actions.

18. The security checkpoint system of claim 17, wherein the artificial intelligence is configured to correlate movements detected in the wireframe model with audio data collected from the security checkpoint area to enhance evasion detection accuracy.

19. The security checkpoint system of claim 17, wherein the artificial intelligence is configured to identify patterns of movement associated with known evasion techniques.

20. The method of claim 11, further comprising using artificial intelligence to analyze the movements of the wireframe model for potential evasive actions.

21. The method of claim 20, wherein the artificial intelligence comprises a machine learning model that is periodically updated with data points collected from the security checkpoint area.

22. The method of claim 20, wherein the artificial intelligence is configured to adapt its analysis based on a set of specific security screening equipment deployed in the security checkpoint area.
